(19) United States
(12) Patent Application Publication
(10) Pub. No.: US 2020/0081456 A1
(43) Pub. Date: Mar. 12, 2020

(54) PLURALITY OF AUTONOMOUS MOBILE ROBOTS AND CONTROLLING METHOD FOR THE SAME

(71) Applicant: LG ELECTRONICS INC., Seoul (KR)

(72) Inventors: Donghoon KWAK, Seoul (KR); Kyoungsuk KO, Seoul (KR); Sungwook LEE, Seoul (KR)

(73) Assignee: LG ELECTRONICS INC., Seoul (KR)

(21) Appl. No.: 16/553,289

(22) Filed: Aug. 28, 2019

Related U.S. Application Data
(60) Provisional application No. 62/727,562, filed on Sep. 6, 2018.

(30) Foreign Application Priority Data
Feb. 20, 2019 (KR) 10-2019-0020081

(51) Int. Cl. G05D 1/02; G05D 1/00

(52) U.S. Cl. CPC G05D 1/0289; G05D 1/0255; G05D 2201/0203; G05D 1/0251; G05D 1/0088; G05D 1/0238

(57) ABSTRACT

A plurality of autonomous mobile robots are disclosed. The mobile robots may include a mobile robot that has a traveling unit that moves or rotates a main body of the mobile robot. The mobile robot has a sensor that detects another mobile robot in a detection area spanning a predetermined angle with respect to the front of the main body. The mobile robot also has a controller that rotates the detection area of the mobile robot when the other mobile robot detected within the detection area moves out of the detection area.

### CROSS-REFERENCE TO RELATED APPLICATION

Pursuant to 35 U.S.C. § 119(a), this application claims the benefit of an earlier filing date of and the right of priority to Korean Application No. 10-2019-0020081, filed on Feb. 20, 2019, and U.S. Provisional Application No. 62/727,562, filed on Sep. 6, 2018, the contents of all of which are incorporated by reference herein in their entireties.

### BACKGROUND OF THE DISCLOSURE

### 1. Field

The present disclosure relates to a plurality of autonomous mobile robots.

### 2. Description of the Related Art

Generally, a mobile robot is a device that automatically performs a predetermined operation while traveling by itself in a predetermined area without a user's operation. The mobile robot senses obstacles located in the area and performs its operations by moving close to or away from such obstacles.

Such mobile robot may include a robot cleaner that performs cleaning while traveling in an area.

The robot cleaner is a cleaner that performs cleaning while traveling by itself without user's operation. In this manner, with the development of such mobile robots performing cleaning while traveling by themselves without users' operations, necessity to make a plurality of mobile robots perform cleaning in a collaborating manner without users' operations is emerging as an interest.

The prior art document WO2017-036532 discloses a method in which a master robot cleaner (hereinafter, referred to as a master robot) controls at least one slave robot cleaner (hereinafter, referred to as a slave robot).

The prior art document discloses a configuration in which the master robot detects adjacent obstacles by using an obstacle detection device and determines its position related to the slave robot using position data derived from the obstacle detection device.

In addition, the prior art discloses a configuration in which the master robot and the slave robot perform communication with each other via a server using wireless local area network (WLAN) technology.

According to the prior art document, the master robot can determine the position of the slave robot but the slave robot cannot determine the position of the master robot.

Further, in order for the slave robot to determine (decide) the position of the master robot using the configuration disclosed in the prior art document, the master robot must transmit relative position information regarding the slave robot determined by the master robot to the slave robot through the server.

However, the prior art fails to disclose such a configuration in which the master robot transmits relative position information to the slave robot via the server.

In addition, even if it is assumed that the master robot transmits relative position information, the master robot and the slave robot should perform communication only through the server. Accordingly, such communication with the server may be disconnected when the master robot or the slave robot is located at a place where it is difficult to communicate with a server.

In this case, since the slave robot does not receive the relative position information from the server, the slave robot may find it difficult to determine the relative position of the master robot, which may cause a problem that smooth follow-up control of the master robot and the slave robot is not performed.

In order to perform smooth follow-up control through communication between a plurality of autonomous mobile robots, it is necessary to determine whether the master robot is located at the front or at the rear of the slave robot, or whether the slave robot is located at the front or at the rear of the master robot.

However, since the prior art document merely discloses that the master robot transmits the relative position information to the slave robot through the server, it is impossible to determine whether the master robot is located at the front or at the rear of the slave robot, or whether the slave robot is located at the front or at the rear of the master robot.

### SUMMARY OF THE DISCLOSURE

One aspect of the present disclosure is to provide mobile robots, capable of performing cleaning in an optimized manner without user's intervention, and a control method thereof.

Another aspect of the present disclosure is to provide mobile robots that one of a plurality of mobile robots follows another one in an optimized manner, and a control method thereof.

Still another aspect of the present disclosure is to provide mobile robots, capable of recognizing relative positions of a plurality of mobile robots, irrespective of a communication state between the plurality of mobile robots and a server, and a control method thereof.

Still another aspect of the present disclosure is to provide mobile robots each of which is configured to recognize a direction that another robot is located with respect to the front so as to perform smooth following control, and a control method thereof.

Still another aspect of the present disclosure is to provide mobile robots that a second mobile robot following a first mobile robot can follow the first mobile robot without failure, and a control method thereof.

To achieve these and other advantages and in accordance with the purpose of this disclosure, as embodied and broadly described herein, there is provided a mobile robot, including a traveling unit to move or rotate a main body, a sensing unit to sense another mobile robot in a detection area having a predetermined angle with respect to the front of the main body, and a controller to control the traveling unit to rotate the main body when the another mobile robot sensed within the detection area moves out of the detection area.

In an embodiment, the controller may rotate the main body so that the another mobile robot is located back in the detection area when the another mobile robot moves out of the detection area.

In an embodiment, the controller may determine through the sensing unit a direction that the another mobile robot moves out of the detection area, and rotate the main body in a direction corresponding to the determined direction.

In an embodiment, the controller may rotate the main body in a left direction when the another mobile robot moves out of the detection area in the left direction, and rotate the main body in a right direction when the another mobile robot moves out of the detection area in the right direction.

In an embodiment, the controller may control the traveling unit to move the main body toward the another mobile robot sensed within the detection area.

In an embodiment, the controller may travel the main body to correspond to a traveling path of the another mobile robot sensed within the detection area.

In an embodiment, the controller may determine at least one point corresponding to a position of the another mobile robot sensed within the detection area, and control the traveling unit to move the main body to the determined at least one point.

In an embodiment, the controller may determine a plurality of positions of the another mobile robot within the detection area in a sequential manner according to a lapse of time, in response to the movement of the another mobile robot, and control the main body to travel via a plurality of points corresponding to the plurality of positions in the sequential manner.

In an embodiment, the controller may move the main body to a position of the another mobile robot within the detection area, stop the movement of the main body to rotate the main body so that the another mobile robot is sensed within the detection area again when it is sensed that the another mobile robot moves out of the detection area during the movement, and stop the rotation of the main body to restart the movement of the main body when the another mobile robot is sensed within the detection area again due to the rotation.

In an embodiment, the controller may determine a first point corresponding to a position of the another mobile robot sensed within the detection area while the main body faces a first direction, rotate the main body so that the another mobile robot is sensed within the detection area again when the another mobile robot moves out of the detection area, determine a second point corresponding to a position of the another mobile robot sensed within the detection area while the main body faces a second direction due to the rotation, and stop the rotation so as to control the main body to travel sequentially via the first point and the second point when a preset condition is satisfied.

In an embodiment, the preset condition may include at least one of a case where a distance between the main body and the another mobile robot is a predetermined distance or more, and a case where a traveling distance by which the main body has to travel sequentially via the first point and the second point is a predetermined distance or more.

In an embodiment, the controller may rotate the main body to face the first direction and thereafter control the main body to travel sequentially via the first point and the second point when the preset condition is satisfied while the main body faces the second direction.

In an embodiment, the mobile robot may further include a communication unit to perform communication with the another mobile robot, and the controller may transmit to the another mobile robot a control signal for stopping the movement of the another mobile robot through the communication unit, in response to an entrance into a state where a preset condition is satisfied.

In an embodiment, the preset condition may include at least one of a case where a distance between the main body and the another mobile robot is a predetermined distance or more, and a case where a traveling distance by which the main body has to travel along a traveling path of the another mobile robot is a predetermined distance or more.

In an embodiment, the controller may transmit to the another mobile robot a control signal for restarting the movement of the another mobile robot through the communication unit, in response to an entrance into a state where the preset condition is not satisfied from the state where the preset condition is satisfied.

In an embodiment, the mobile robot may further include a communication unit to perform communication with the another mobile robot, and the controller may transmit to the another mobile robot a control signal for stopping the movement of the another mobile robot through the communication unit when the another mobile robot moves out of the detection area.

In an embodiment, the controller may transmit to the another mobile robot a control signal for restarting the movement of the another mobile robot through the communication unit when the another mobile robot is sensed within the detection area again due to the rotation of the main body after the another mobile robot has moved out of the detection area.

To achieve these and other advantages and in accordance with the purpose of this disclosure, as embodied and broadly described herein, there is provided a method for controlling a mobile robot, the method including sensing another mobile robot within a detection area having a preset angle with respect to the front of a main body, and rotating the main body when the another mobile robot sensed within the detection area moves out of the detection area.

The present disclosure provides a plurality of autonomous mobile robots capable of accurately determining a relative position of another mobile robot.

The present disclosure provides mobile robots capable of smoothly performing a following travel in a manner that another mobile robot follows a mobile robot without failure even if the another mobile robot moves out of a detection area of the mobile robot.

The present disclosure provides a new following control method, capable of preventing a mobile robot from missing another mobile robot by rotating the mobile robot so as to detect the another mobile robot again in a detection area of the mobile robot when the another mobile robot moves out of the detection area, and allowing the mobile robot to follow the another mobile robot even if the another mobile robot moves out of the detection area of the mobile robot.

The present disclosure provides mobile robots such that a mobile robot can always recognize a relative position or a traveling path of another mobile robot by way of rotating the mobile robot so that the another mobile robot can be sensed again within a detection area of the mobile robot when the another mobile robot moves out of the detection area.

### BRIEF DESCRIPTION OF THE DRAWINGS

FIG. 1 is a perspective view illustrating one embodiment of a robot cleaner according to the present disclosure.

FIG. 2 is a planar view of the autonomous mobile robot illustrated in FIG. 1.

FIG. 3 is a lateral view of the autonomous mobile robot illustrated in FIG. 1.

FIG. 4 is a block diagram illustrating exemplary components of an autonomous mobile robot according to one embodiment of the present disclosure.

FIG. 5A is a conceptual view illustrating network communication between a plurality of autonomous mobile robots according to one embodiment of the present disclosure, and FIG. 5B is a conceptual view illustrating an example of the network communication of FIG. 5A.

FIG. 5C is a conceptual view illustrating a following travel of a plurality of autonomous mobile robots according to one embodiment of the present disclosure.

FIGS. 6A, 6B and 6C are conceptual views illustrating follow-up registration and follow-up control between a first mobile robot and a mobile device, according to an alternative embodiment of the present disclosure.

FIG. 7 is a flowchart illustrating a representative control method according to the present disclosure.

FIGS. 8A, 8B, 9A, 9B, 10A, and 10B are conceptual views illustrating the control method illustrated in FIG. 7.

FIG. 11 is a flowchart illustrating a more detailed control method according to the present disclosure.

FIGS. 12A-12E, 13A, and 13B are conceptual views illustrating the control method illustrated in FIG. 11.

FIG. 14 is a flowchart illustrating an additional control method according to the present disclosure.

FIGS. 15A and 15B are a conceptual view illustrating the control method illustrated in FIG. 14.

### DETAILED DESCRIPTION

Hereinafter, autonomous mobile robots according to the present disclosure will be described in detail with reference to the accompanying drawings.

Hereinafter, description will be given in detail of embodiments disclosed herein. Technical terms used in this disclosure are merely used for explaining specific embodiments, and should not be construed to limit the scope of the technology disclosed herein.

First, the term “mobile robot” disclosed herein may have the same meaning as ‘robot (for a specific function),’ ‘robot cleaner,’ ‘robot for cleaning’ and ‘autonomous cleaner,’ and those terms will be used interchangeably.

A “plurality of mobile robots” disclosed in the present disclosure may include a “plurality of robot cleaners” or “a plurality of cleaners”. Also, a “first mobile robot” may be named “first robot”, “first robot cleaner”, “first cleaner”, or “leading or master cleaner”. Further, a “second mobile robot” may be named as “second robot”, “second robot cleaner”, “second cleaner”, or “following or slave cleaner”.

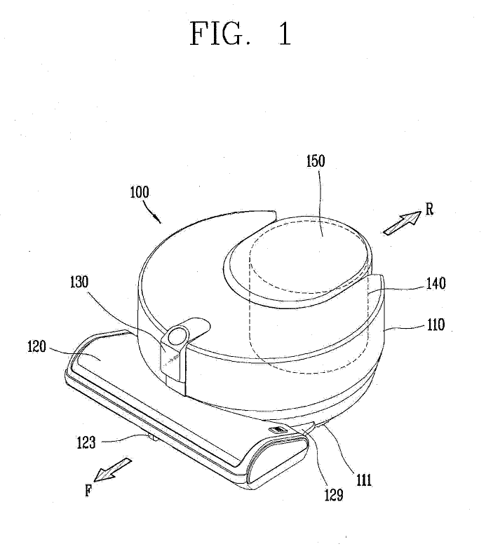

FIGS. 1 to 3 illustrate a robot cleaner as an example of a mobile robot according to the present disclosure.

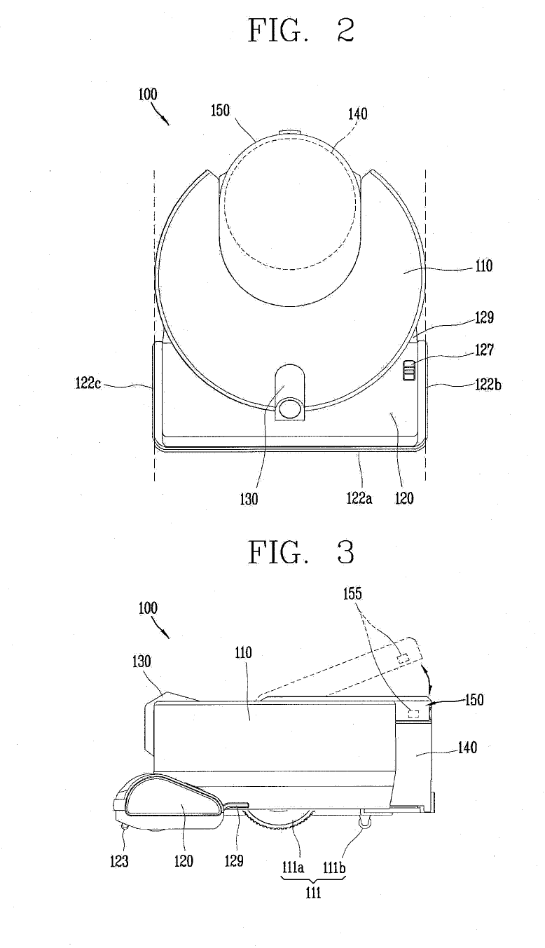

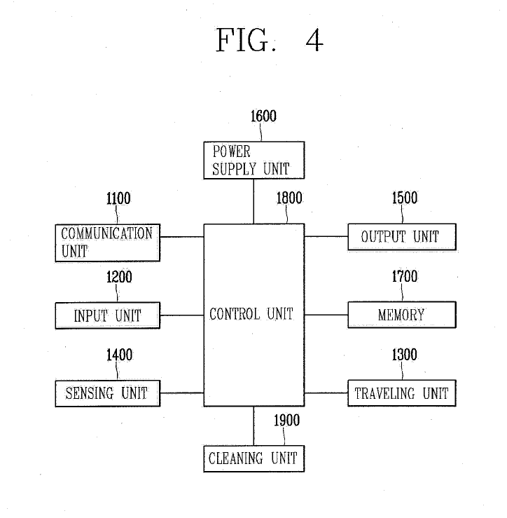

FIG. 1 is a perspective view illustrating one embodiment of an autonomous mobile robot 100 according to the present disclosure, FIG. 2 is a planar view of the autonomous mobile robot 100 illustrated in FIG. 1, and FIG. 3 is a lateral view of the autonomous mobile robot 100 illustrated in FIG. 1.

In this disclosure, a mobile robot, an autonomous mobile robot, and a cleaner that performs autonomous traveling may be used in the same sense. In this disclosure, a plurality of autonomous mobile robots may include at least part of configurations illustrated in FIGS. 1 to 3.

Referring to FIGS. 1 to 3, an autonomous mobile robot 100 performs a function of cleaning a floor while traveling on a predetermined area by itself. Cleaning the floor disclosed herein includes sucking dust (including foreign materials) on the floor or mopping the floor.

The autonomous mobile robot 100 may include a cleaner main body 110, a cleaning unit 120, a sensing unit 130, and a dust bin 140.

The cleaner main body 110 is provided with various components in addition to a controller (not illustrated) for controlling the mobile robot 100. In addition, the cleaner main body 110 is provided with a wheel unit 111 for traveling the autonomous mobile robot 100. The autonomous mobile robot 100 may be moved or rotated forward, backward, left or right by the wheel unit 111.

Referring to FIG. 3, the wheel unit 111 includes main wheels 111a and a sub wheel 111b.

The main wheels 111a are provided on both sides of the cleaner main body 110 and configured to be rotatable in one direction or another direction according to a control signal of the control unit. Each of the main wheels 111a may be configured to be driven independently of each other. For example, each main wheel 111a may be driven by a different motor. Or each main wheel 111a may be driven by a plurality of different axes provided in one motor.

The sub wheel 111b supports the cleaner main body 110 together with the main wheels 111a and assists the traveling of the autonomous mobile robot 100 by the main wheels 111a. The sub wheel 111b may also be provided on a cleaning unit 120 to be described later.

The control unit controls the driving of the wheel unit 111, so that the autonomous mobile robot 100 is allowed to autonomously travel on the floor.

Meanwhile, the cleaner main body 110 is provided with a battery (not shown) for supplying power to the autonomous mobile robot 100. The battery 190 may be configured to be rechargeable, and may be detachably disposed in a bottom portion of the cleaner main body 110.

In FIG. 1, a cleaning unit 120 may be disposed in a protruding form from one side of the cleaner main body 110, so as to suck air containing dust or mop an area. The one side may be a side where the cleaner main body 110 travels in a forward direction F, that is, a front side of the cleaner main body 110.

In this drawing, the cleaning unit 120 is shown having a shape protruding from one side of the cleaner main body 110 to front and both left and right sides. Specifically, a front end portion of the cleaning unit 120 is disposed at a position spaced forward apart from the one side of the cleaner main body 110, and left and right end portions of the cleaning unit 120 are disposed at positions spaced apart from the one side of the cleaner main body 110 in the right and left directions.

As the cleaner main body 110 is formed in a circular shape and both sides of a rear end portion of the cleaning unit 120 protrude from the cleaner main body 110 to both left and right sides, empty spaces, namely, gaps may be formed between the cleaner main body 110 and the cleaning unit 120. The empty spaces are spaces between both left and right end portions of the cleaner main body 110 and both left and right end portions of the cleaning unit 120 and each has a shape recessed into the autonomous mobile robot 100.

If an obstacle is caught in the empty space, the autonomous mobile robot 100 may be likely to be unmovable due to the obstacle. To prevent this, a cover member 129 may be disposed to cover at least part of the empty space.

The cover member 129 may be provided on the cleaner main body 110 or the cleaning unit 120. In an embodiment of the present disclosure, the cover member 129 protrudes from each of both sides of the rear end portion of the cleaning unit 120 and covers an outer circumferential surface of the cleaner main body 110.

The cover member 129 is disposed to fill at least part of the empty space, that is, the empty space between the cleaner main body 110 and the cleaning unit 120. This may result in realizing a structure capable of preventing an obstacle from being caught in the empty space, or to easily escape an obstacle even if the obstacle is caught in the empty space.

The cover member 129 protruding from the cleaning unit 120 may be supported on the outer circumferential surface of the cleaner main body 110.

The cover member 129 may be supported on a rear portion of the cleaning unit 120 if the cover member 129 protrudes from the cleaner main body 110. According to this structure, when the cleaning unit 120 is impacted due to colliding with an obstacle, a part of the impact is transferred to the cleaner main body 110 so as to be dispersed.

The cleaning unit 120 may be detachably coupled to the cleaner main body 110. When the cleaning unit 120 is detached from the cleaner main body 110, a mop module (not shown) may be detachably coupled to the cleaner main body 110 in place of the detached cleaning unit 120.

Accordingly, the user can mount the cleaning unit 120 on the cleaner main body 110 when the user wishes to remove dust on the floor, and may mount the mop module on the cleaner main body 110 when the user wants to mop the floor.

When the cleaning unit 120 is mounted on the cleaner main body 110, the mounting may be guided by the cover member 129 described above. That is, as the cover member 129 is disposed to cover the outer circumferential surface of the cleaner main body 110, a relative position of the cleaning unit 120 with respect to the cleaner main body 110 may be determined.

The cleaning unit 120 may be provided with a castor 123. The caster 123 assists the running of the autonomous mobile robot 100 and also supports the autonomous mobile robot 100.

The cleaner main body 110 is provided with a sensing unit 130. As illustrated, the sensing unit 130 may be disposed on one side of the cleaner main body 110 where the cleaning unit 120 is located, that is, on a front side of the cleaner main body 110.

The sensing unit 130 may be disposed to overlap the cleaning unit 120 in an up and down direction of the cleaner main body 110. The sensing unit 130 is disposed at an upper portion of the cleaning unit 120 so as to detect an obstacle or feature in front of the robot so that the cleaning unit 120 positioned at the forefront of the autonomous mobile robot 100 does not hit the obstacle.

The sensing unit 130 may be configured to additionally perform another sensing function other than the sensing function.

By way of example, the sensing unit 130 may include a camera 131 for acquiring surrounding images. The camera 131 may include a lens and an image sensor. The camera 131 may convert a surrounding image of the cleaner main body 110 into an electrical signal that can be processed by the control unit. For example, the camera 131 may transmit an electrical signal corresponding to an upward image to the control unit. The electrical signal corresponding to the upward image may be used by the control unit to detect the position of the cleaner main body 110.

In addition, the sensing unit 130 may detect obstacles such as walls, furniture, and cliffs on a traveling surface or a traveling path of the autonomous mobile robot 100. Also, the sensing unit 130 may sense presence of a docking device that performs battery charging. Also, the sensing unit 130 may detect ceiling information so as to map a traveling area or a cleaning area of the autonomous mobile robot 100.

The cleaner main body 110 is provided with a dust container 140 detachably coupled thereto for separating and collecting dust from sucked air.

The dust container 140 is provided with a dust container cover 150 which covers the dust container 140. In an embodiment, the dust container cover 150 may be coupled to the cleaner main body 110 by a hinge to be rotatable. The dust container cover 150 may be fixed to the dust container 140 or the cleaner main body 110 to keep covering an upper surface of the dust container 140. The dust container 140 may be prevented from being separated from the cleaner main body 110 by the dust container cover 150 when the dust container cover 150 is disposed to cover the upper surface of the dust container 140.

A part of the dust container 140 may be accommodated in a dust container accommodating portion and another part of the dust container 140 protrudes toward the rear of the cleaner main body 110 (i.e., a reverse direction R opposite to a forward direction F).

The dust container 140 is provided with an inlet through which air containing dust is introduced and an outlet through which air separated from dust is discharged. The inlet and the outlet communicate with each other through an opening 155 formed through an inner wall of the cleaner main body 110 when the dust container 140 is mounted on the cleaner main body 110. Thus, an intake passage and an exhaust passage inside the cleaner main body 110 may be formed.

According to such connection, air containing dust introduced through the cleaning unit 120 flows into the dust container 140 through the intake passage inside the cleaner main body 110 and the air is separated from the dust while passing through a filter and cyclone of the dust container 140. The separated dust is collected in the dust container 140, and the air is discharged from the dust container 140 and flows along the exhaust passage inside the cleaner main body 110 so as to be externally exhausted through an exhaust port.

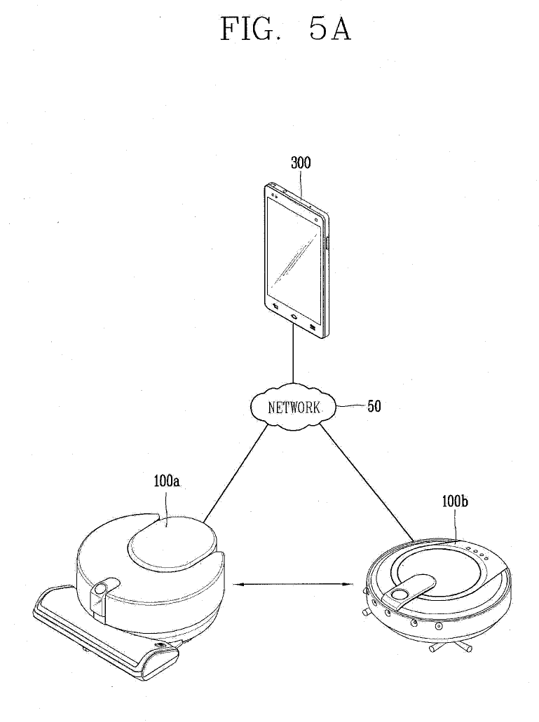

Hereinafter, an embodiment related to the components of the autonomous mobile robot 100 will be described with reference to FIG. 4.

An autonomous mobile robot 100 or a mobile robot according to an embodiment of the present disclosure may include a communication unit 1100, an input unit 1200, a traveling unit 1300, a sensing unit 1400, an output unit 1500, a power supply unit 1600, a memory 1700, a control unit 1800, and a cleaning unit 1900, or a combination thereof.

At this time, those components shown in FIG. 4 are not essential, and an autonomous mobile robot having greater or fewer components can be implemented. Also, as described above, each of a plurality of autonomous mobile robots described in the present disclosure may equally include only some of components to be described below. That is, a plurality of autonomous mobile robots may include different components.

Hereinafter, each component will be described.

First, the power supply unit 1600 includes a battery that can be charged by an external commercial power supply, and supplies power to the mobile robot. The power supply unit 1600 supplies driving force to each of the components included in the mobile robot to supply operating power required for the mobile robot to travel or perform a specific function.

At this time, the control unit 1800 may detect a remaining amount of power (or remaining power level or battery level) of the battery. The control unit 1800 may control the mobile robot to move to a charging base connected to the external commercial power supply when the remaining power is insufficient, so that the battery can be charged by receiving charging current from the charging base. The battery may be connected to a battery sensing portion so that a remaining power level and a charging state can be transmitted to the control unit 1800. The output unit 1500 may display the remaining battery level under the control of the control unit.

The battery may be located in a bottom portion of a center of the autonomous mobile robot, or may be located in either the left or right side. In the latter case, the mobile robot may further include a balance weight to eliminate weight bias of the battery.

The control unit 1800 performs processing of information based on an artificial intelligence (AI) technology and may include one or more modules that perform at least one of learning of information, inference of information, perception of information, and processing of natural language.

The control unit 1800 may use a machine running technology to perform at least one of learning, inferring and processing a large amount of information (big data), such as information stored in the cleaner, environmental information around a mobile terminal, information stored in an external storage capable of performing communication, and the like. The control unit 1800 may control the cleaner to predict (or infer) at least one executable operation and execute an operation having the highest feasibility among the predicted at least one operation, by using the information learned using the machine running technology.

Machine learning technology is a technology that collects and learns a large amount of information based on at least one algorithm, and judges and predicts information based on the learned information. The learning of information is an operation that grasps characteristics, rules, and judgment criteria of information, quantifies relationship between information and information, and predicts new data using a quantified pattern.

The at least one algorithm used by the machine learning technology may be a statistical based algorithm, for example, a decision tree that uses a tree structure type as a prediction model, an artificial neural network copying neural network architecture and functions, genetic programming based on biological evolutionary algorithms, clustering to distribute observed examples into subsets of clusters, Monte Carlo method to compute function values through randomly extracted random numbers from probability, or the like.

As a field of machine learning technology, deep learning is a technique that performs at least one of learning, judging, and processing of information using an Artificial Neural Network (ANN) or a Deep Neuron Network (DNN) algorithm. Such DNN may have an architecture in which layers are connected to transfer data between layers. This deep learning technology may allow learning of a large amount of information through the DNN using a graphic processing unit (GPU) optimized for parallel computing.

The control unit 1800 may use training data stored in an external server or memory, and may include a learning engine mounted to detect characteristics for recognizing a predetermined object. At this time, the characteristics for recognizing the object may include a size, shape and shade of the object.

Specifically, when the control unit 1800 inputs a part of images acquired through the camera provided on the cleaner into the learning engine, the learning engine may recognize at least one object or organism included in the input images.

When the learning engine is applied to traveling of the cleaner, the control unit 1800 can recognize whether or not an obstacle such as a chair leg, a fan, and a specific shape of balcony gap, which obstruct the running of the cleaner, exists around the cleaner. This may result in enhancing efficiency and reliability of the traveling of the cleaner.

On the other hand, the learning engine may be mounted on the control unit 1800 or on an external server. When the learning engine is mounted on an external server, the control unit 1800 may control the communication unit 1100 to transmit at least one image to be analyzed, to the external server.

The external server may input the image transmitted from the cleaner into the learning engine and thus recognize at least one object or organism included in the image. In addition, the external server may transmit information related to the recognition result back to the cleaner. In this case, the information related to the recognition result may include information related to the number of objects included in the image to be analyzed and a name of each object.

On the other hand, the traveling unit 1300 may include a motor, and operate the motor to bidirectionally rotate left and right main wheels, so that the main body can rotate or move. At this time, the left and right main wheels may be independently moved. The traveling unit 1300 may advance the main body of the mobile robot forward, backward, left, right, curvedly, or in place.

On the other hand, the input unit 1200 receives various control commands for the autonomous mobile robot from the user. The input unit 1200 may include one or more buttons, for example, the input unit 1200 may include an OK button, a setting button, and the like. The OK button is a button for receiving a command for confirming detection information, obstacle information, position information, and map information from the user, and the setting button is a button for receiving a command for setting those information from the user.

In addition, the input unit 1200 may include an input reset button for canceling a previous user input and receiving a new user input, a delete button for deleting a preset user input, a button for setting or changing an operation mode, a button for receiving an input to return to the charging base.

In addition, the input unit 1200 may be implemented as a hard key, a soft key, a touch pad, or the like and may be disposed on a top of the mobile robot. For example, the input unit 1200 may implement a form of a touch screen together with the output unit 1500.

On the other hand, the output unit 1500 may be installed on a top of the mobile robot. Of course, an installation location and an installation type may vary. For example, the output unit 1500 may display a battery level state, a traveling mode or manner, or the like on a screen.

The output unit 1500 may output internal status information of the mobile robot detected by the sensing unit 1400, for example, a current status of each component included in the mobile robot. The output unit 1500 may also display external status information detected by the sensing unit 1400, obstacle information, position information, map information, and the like on the screen. The output unit 1500 may be configured as one device of a light emitting diode (LED), a liquid crystal display (LCD), a plasma display panel, and an organic light emitting diode (OLED).

The output unit 1500 may further include an audio output module for audibly outputting information related to an operation of the mobile robot executed by the control unit 1800 or an operation result. For example, the output unit 1500 may output warning sound to the outside in response to a warning signal generated by the control unit 1800.

In this case, the audio output module (not shown) may be means, such as a beeper, a speaker or the like for outputting sounds, and the output unit 1500 may output sounds to the outside through the audio output module using audio data or message data having a predetermined pattern stored in the memory 1700.

Accordingly, the mobile robot according to an embodiment of the present disclosure can output environmental information related to a traveling area through the output unit 1500 or output the same in an audible manner. According to another embodiment, the mobile robot may transmit map information or environmental information to a terminal device through the communication unit 1100 so that the terminal device outputs a screen to be output through the output unit 1500 or sounds.

The memory 1700 stores a control program for controlling or driving the autonomous mobile robot and data corresponding thereto. The memory 1700 may store audio information, image information, obstacle information, position information, map information, and the like. Also, the memory 1700 may store information related to a traveling pattern.

The memory 1700 mainly uses a nonvolatile memory. Here, the non-volatile memory (NVM, NVRAM) is a storage device that can continuously store information even when power is not supplied. Examples of the storage device include a ROM, a flash memory, a magnetic computer storage device (e.g., a hard disk, a diskette drive, a magnetic tape), an optical disk drive, a magnetic RAM, a PRAM, and the like.

On the other hand, the sensing unit 1400 may include at least one of an external signal sensor, a front sensor, a cliff sensor, a two-dimensional (2D) camera sensor, and a three-dimensional (3D) camera sensor.

The external signal sensor or external signal detection sensor may sense an external signal of a mobile robot. The external signal sensor may be, for example, an infrared ray (IR) sensor, an ultrasonic sensor, a radio frequency (RF) sensor, or the like.

The mobile robot may detect a position and direction of the charging base by receiving a guidance signal generated by the charging base using the external signal sensor. At this time, the charging base may transmit a guidance signal indicating a direction and distance so that the mobile robot can return thereto. That is, the mobile robot may determine a current position and set a moving direction by receiving a signal transmitted from the charging base, thereby returning to the charging base.

On the other hand, the front sensors or front detection sensors may be installed at a predetermined distance on the front of the mobile robot, specifically, along a circumferential surface of a side surface of the mobile robot. The front sensor is located on at least one side surface of the mobile robot to detect an obstacle in front of the mobile robot. The front sensor may detect an object, especially an obstacle, existing in a moving direction of the mobile robot and transmit detection information to the control unit 1800. That is, the front sensor may detect protrusions on the moving path of the mobile robot, household appliances, furniture, walls, wall corners, and the like, and transmit the information to the control unit 1800.

For example, the frontal sensor may be an infrared ray (IR) sensor, an ultrasonic sensor, an RF sensor, a geomagnetic sensor, or the like, and the mobile robot may use one type of sensor as the front sensor or two or more types of sensors if necessary.

An ultrasonic sensor, for example, may generally be used to detect a remote obstacle. The ultrasonic sensor may be provided with a transmitter and a receiver. The control unit 1800 may determine presence or non-presence of an obstacle according to whether ultrasonic waves radiated from the transmitter are reflected by an obstacle or the like and then received by the receiver, and calculate a distance from the obstacle using a ultrasonic wave radiation time and a ultrasonic wave reception time.

Also, the control unit 1800 may detect information related to a size of an obstacle by comparing ultrasonic waves radiated from the transmitter with ultrasonic waves received by the receiver. For example, the control unit 1800 may determine that the obstacle is larger in size when more ultrasonic waves are received in the receiver.

In one embodiment, a plurality (e.g., five) of ultrasonic sensors may be installed on side surfaces of the mobile robot at the front side along an outer circumferential surface. At this time, the ultrasonic sensors may preferably be installed on the front surface of the mobile robot in a manner that the transmitter and the receiver are alternately arranged.

That is, the transmitters may be disposed at right and left sides with being spaced apart from a front center of the main body or one transmitter or at least two transmitters may be disposed between the receivers so as to form a reception area of an ultrasonic signal reflected from an obstacle or the like. With this arrangement, the reception area can increase while reducing the number of sensors. A radiation angle of ultrasonic waves may be maintained in a range of avoiding an affection to different signals so as to prevent a crosstalk. Also, receiving sensitivity of the receivers may be set differently.

In addition, the ultrasonic sensor may be installed upward by a predetermined angle so that the ultrasonic waves emitted from the ultrasonic sensor are output upward. In this instance, the ultrasonic sensor may further include a predetermined blocking member to prevent the ultrasonic waves from being radiated downward.

On the other hand, as described above, the front sensor may be implemented by using two or more types of sensors together, and thus the front sensor may use any one of an IR sensor, an ultrasonic sensor, an RF sensor and the like.

For example, the front sensor may include an IR sensor as another sensor, in addition to the ultrasonic sensor.

The IR sensor may be installed on an outer circumferential surface of the mobile robot together with the ultrasonic sensor. The IR sensor may also detect an obstacle existing on a front or side of the mobile robot and transmit obstacle information to the control unit 1800. That is, the IR sensor senses a protrusion, a household fixture, furniture, a wall, a wall edge, and the like, existing on the moving path of the mobile robot, and transmits detection information to the control unit 1800. Therefore, the mobile robot can move within a specific area without collision with an obstacle.

On the other hand, a cliff sensor (or cliff detection sensor) may detect an obstacle on the floor supporting the main body of the mobile robot by mainly using various types of optical sensors.

That is, the cliff sensor may also be installed on a rear surface of the mobile robot on the floor, but may be installed on a different position depending on a type of the mobile robot. The cliff sensor is located on the rear surface of the mobile robot and detects an obstacle on the floor. The cliff sensor may be an IR sensor, an ultrasonic sensor, an RF sensor, a Position Sensitive Detector (PSD) sensor, and the like, which include a transmitter and a receiver, similar to the obstacle detection sensor.

For example, one of the cliff sensors may be installed on the front of the mobile robot, and two other cliff sensors may be installed relatively behind.

For example, the cliff sensor may be a PSD sensor, but may alternatively be configured by a plurality of different kinds of sensors.

The PSD sensor detects a short/long distance location of incident light at one p-n junction using semiconductor surface resistance. The PSD sensor includes a one-dimensional PSD sensor that detects light only in one axial direction, and a two-dimensional PSD sensor that detects a light position on a plane. Both of the PSD sensors may have a pin photodiode structure. As a type of infrared sensor, the PSD sensor uses infrared rays. The PSD sensor emits infrared ray, and measures a distance by calculating an angle of the infrared ray reflected and returned from an obstacle. That is, the PSD sensor calculates a distance from the obstacle by using the triangulation method.

The PSD sensor includes a light emitter that emits infrared rays to an obstacle and a light receiver that receives infrared rays that are reflected and returned from the obstacle, and is configured typically as a module type. When an obstacle is detected by using the PSD sensor, a stable measurement value may be obtained irrespective of reflectivity and color difference of the obstacle.

The control unit 1800 may measure an infrared ray angle between a light signal of infrared ray emitted by the cliff detection sensor toward the ground and a reflection signal reflected and received from an obstacle, so as to detect a cliff and analyze a depth of the cliff.

Meanwhile, the control unit 1800 may determine whether to pass a cliff or not according to a ground state of the detected cliff by using the cliff detection sensor, and decide whether to pass the cliff or not according to the determination result. For example, the control unit 1800 determines presence or non-presence of a cliff and a depth of the cliff through the cliff sensor, and then allows the mobile robot to pass through the cliff only when a reflection signal is detected through the cliff sensor.

As another example, the control unit 1800 may also determine lifting of the mobile robot using the cliff sensor.

On the other hand, the two-dimensional camera sensor is provided on one surface of the mobile robot to acquire image information related to the surroundings of the main body during movement.

An optical flow sensor converts a lower image input from an image sensor provided in the sensor to generate image data of a predetermined format. The generated image data may be stored in the memory 1700.

Also, at least one light source may be installed adjacent to the optical flow sensor. The at least one light source emits light to a predetermined area of the floor, which is captured by the image sensor. That is, while the mobile robot moves in a specific area along the floor surface, a certain distance is maintained between the image sensor and the floor surface when the floor surface is flat. On the other hand, when the mobile robot moves on a floor surface which is not flat, the image sensor and the floor surface are spaced apart from each other by a predetermined distance due to an unevenness and an obstacle on the floor surface. At this time, the at least one light source may be controlled by the control unit 1800 to adjust an amount of light to be emitted. The light source may be a light emitting device, for example, a light emitting diode (LED), which is capable of adjusting an amount of light.

The control unit 1800 may detect a position of the mobile robot irrespective of slippage of the mobile robot, using the optical flow sensor. The control unit 1800 may compare and analyze image data captured by the optical flow sensor according to time to calculate a moving distance and a moving direction, and calculate a position of the mobile robot based on the calculated moving distance and moving direction. By using the image information regarding the lower side of the mobile robot captured by the image sensor, the control unit 1800 may perform correction that is robust against slippage with respect to the position of the mobile robot calculated by another member.

The three-dimensional (3D) camera sensor may be attached to one surface or a part of the main body of the mobile robot to generate 3D coordinate information related to surroundings of the main body.

That is, the 3D camera sensor may be a 3D depth camera that calculates a remote/near distance between the mobile robot and an object to be captured.

Specifically, the 3D camera sensor may capture 2D images related to surroundings of the main body, and generate a plurality of 3D coordinate information corresponding to the captured 2D images.

In one embodiment, the 3D camera sensor may be configured in a stereoscopic vision type which includes two or more cameras for acquiring 2D images, and merges at least two images acquired by the two or more cameras to generate a 3D coordinate information.

Specifically, the 3D camera sensor according to the embodiment may include a first pattern irradiating portion for downwardly irradiating light of a first pattern toward the front of the main body, a second pattern irradiating portion for upwardly irradiating light of a second pattern toward the front of the main body, and an image acquiring portion for acquiring a front image of the main body. Thus, the image acquiring portion may acquire an image of an area where the light of the first pattern and the light of the second pattern are incident.

In another embodiment, the 3D camera sensor may include an infrared pattern irradiating portion for irradiating an infrared pattern, in addition to a single camera, and capture a shape that the infrared pattern irradiated from the infrared pattern irradiating portion is projected onto an object to be captured, thereby measuring a distance between the 3D camera sensor and the object to be captured. The 3D camera sensor may be an IR type 3D camera sensor.

In another embodiment, the 3D camera sensor may include a light emitting portion for emitting light, in addition to a single camera. The 3D camera sensor may receive a part of laser light (or laser beam), which is emitted from the light emitting portion and reflected from an object to be captured, and analyze the received light, thereby measuring a distance between the 3D camera sensor and the object to be captured. The 3D camera sensor may be a time-of-flight (TOF) type 3D camera sensor.

Specifically, the laser of the 3D camera sensor is configured to irradiate a laser beam extending in at least one direction. In one example, the 3D camera sensor may be provided with first and second lasers. The first laser irradiates linear laser beams intersecting each other, and the second laser irradiates single linear laser beam. According to this, the lowermost laser is used to detect an obstacle on a bottom, the uppermost laser is used to detect an obstacle on a top, and an intermediate laser between the lowermost laser and the uppermost laser is used to detect an obstacle at a middle portion.

On the other hand, the communication unit 1100 is connected to a terminal device and/or another device (also referred to as “home appliance” herein) through one of wired, wireless and satellite communication methods, so as to transmit and receive signals and data.

The communication unit (or transceiver) 1100 may transmit and receive data with another device located in a specific area. In this case, the another device may be any device if it can transmit and receive data through a network. For example, the another device may be an air conditioner, a heating device, an air purifier, a lamp, a TV, a vehicle, and the like. The another device may also be a device for controlling a door, a window, a water supply valve, a gas valve, or the like. The another device may also be a sensor for detecting temperature, humidity, air pressure, gas, or the like.

Further, the communication unit 1100 may communicate with another autonomous mobile robot 100 located in a specific area or within a predetermined range.

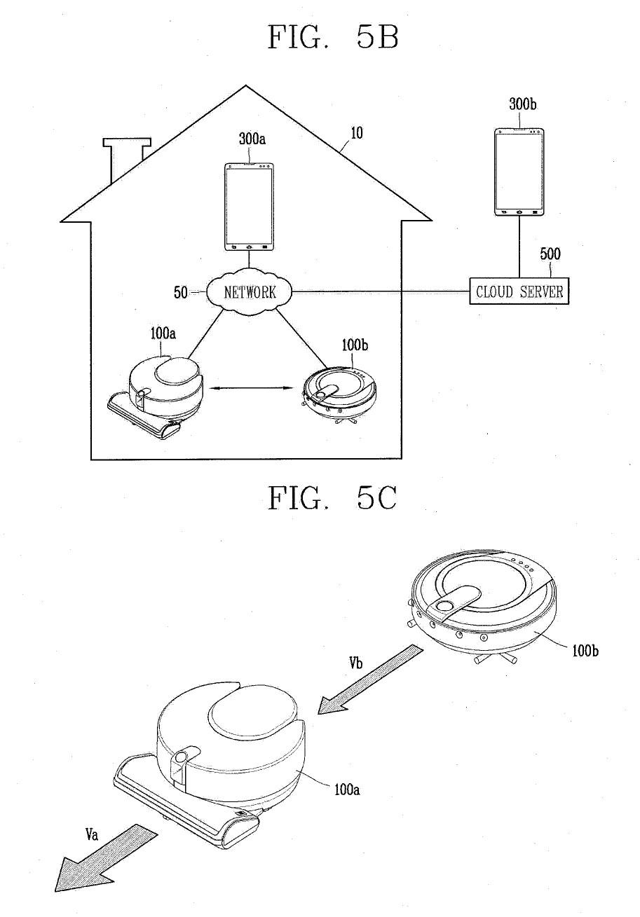

Referring to FIGS. 5A and 5B, a first autonomous mobile robot 100a and a second autonomous mobile robot 100b may exchange data with each other through a network communication 50. In addition, the first autonomous mobile robot 100a and/or the second autonomous mobile robot 100b may perform a cleaning related operation or a corresponding operation by a control command received from a terminal 300 through the network communication 50 or other communication.

That is, although not shown, the plurality of autonomous mobile robots 100a and 100b may perform communication with the terminal 300 through a first network communication and perform communication with each other through a second network communication.

Here, the network communication 50 may refer to short-range communication using at least one of wireless communication technologies, such as a wireless LAN (WLAN), a wireless personal area network (WPAN), a wireless fidelity (Wi-Fi) Wi-Fi direct, Digital Living Network Alliance (DLNA), Wireless Broadband (WiBro), World Interoperability for Microwave Access (WiMAX), Zigbee, Z-wave, Blue-Tooth, Radio Frequency Identification (RFID), Infrared Data Association (IrDA), Ultrawide-Band (UWB), Wireless Universal Serial Bus (USB), and the like.

The network communication 50 may vary depending on a communication mode of the autonomous mobile robots desired to communicate with each other.

In FIG. 5A, the first autonomous mobile robot 100a and/or the second autonomous mobile robot 100b may provide information sensed by the respective sensing units thereof to the terminal 300 through the network communication 50. The terminal 300 may also transmit a control command generated based on the received information to the first autonomous mobile robot 100a and/or the second autonomous mobile robot 100b via the network communication 50.

In FIG. 5A, the communication unit of the first autonomous mobile robot 100a and the communication unit of the second autonomous mobile robot 100b may also directly communicate with each other or indirectly communicate with each other via another router (not shown), to recognize information related to a traveling state and positions of counterparts.

In one example, the second autonomous mobile robot 100b may perform a traveling operation and a cleaning operation according to a control command received from the first autonomous mobile robot 100a. In this case, it may be said that the first autonomous mobile robot 100a operates as a master cleaner and the second autonomous mobile robot 100b operates as a slave cleaner. Alternatively, it can be said that the second autonomous mobile robot 100b follows up the first autonomous mobile robot 100a. In some cases, it may also be said that the first autonomous mobile robot 100a and the second autonomous mobile robot 100b collaborate with each other.

Hereinafter, a system including a plurality of cleaners 100a and 100b performing autonomous traveling according to an embodiment of the present disclosure will be described with reference to FIG. 5B.

As illustrated in FIG. 5B, a cleaning system according to an embodiment of the present disclosure may include a plurality of cleaners 100a and 100b performing autonomous traveling, a network 50, a server 500, and a plurality of terminals 300a and 300b.

The plurality of cleaners 100a and 100b, the network 50 and at least one terminal 300a may be disposed in a building 10 while another terminal 300b and the server 500 may be located outside the building 10.

The plurality of cleaners 100a and 100b are cleaners that perform cleaning while traveling by themselves, and may perform autonomous traveling and autonomous cleaning. Each of the plurality of cleaners 100a and 100b may include a communication unit 1100, in addition to the traveling function and the cleaning function.

The plurality of cleaners 100a and 100b, the server 500 and the plurality of terminals 300a and 300b may be connected together through the network 50 to exchange data. To this end, although not shown, a wireless router such as an access point (AP) device and the like may further be provided. In this case, the terminal 300a located in the building (internal network) 10 may access at least one of the plurality of cleaners 100a and 100b through the AP device so as to perform monitoring, remote control and the like with respect to the cleaner. Also, the terminal 300b located in an external network may access at least one of the plurality of cleaners 100a and 100b through the AP device, to perform monitoring, remote control and the like with respect to the cleaner.

The server 500 may be wirelessly connected directly through the terminal 300b. Alternatively, the server 500 may be connected to at least one of the plurality of cleaners 100a and 100b without passing through the mobile terminal 300b.

The server 500 may include a programmable processor and may include various algorithms. By way of example, the server 500 may be provided with algorithms related to performing machine learning and/or data mining. As an example, the server 500 may include a speech recognition algorithm. In this case, when receiving voice data, the received voice data may be output by being converted into data in a text format.

The server 500 may store firmware information, operation information (course information and the like) related to the plurality of cleaners 100a and 100b, and may register product information regarding the plurality of cleaners 100a and 100b. For example, the server 500 may be a server operated by a cleaner manufacturer or a server operated by an open application store operator.

In another example, the server 500 may be a home server that is provided in the internal network 10 and stores status information regarding the home appliances or stores contents shared by the home appliances. If the server 500 is a home server, information related to foreign substances, for example, foreign substance images and the like may be stored.

Meanwhile, the plurality of cleaners 100a and 100b may be directly connected to each other wirelessly via Zigbee, Z-wave, Blue-Tooth, Ultra-wide band, and the like. In this case, the plurality of cleaners 100a and 100b may exchange position information and traveling information with each other.

At this time, any one of the plurality of cleaners 100a and 100b may be a master cleaner 100a and another may be a slave cleaner 100b.

In this case, the first mobile robot 100a may control traveling and cleaning of the second mobile robot 100b. In addition, the second mobile robot 100b may perform traveling and cleaning while following up the first mobile robot 100a. Here, the operation or action that the second mobile robot 100b follows up the first mobile robot 100a refers to that the second mobile robot 100b performs traveling and cleaning while following up the first mobile robot 100a with maintaining a proper distance from the first mobile robot 100a.

Referring to FIG. 5C, the first mobile robot 100a controls the second mobile robot 100b such that the second mobile robot 100b follows the first mobile robot 100a. For this purpose, the first mobile robot 100a and the second mobile robot 100b should exist in a specific area where they can communicate with each other, and the second mobile robot 100b should recognize at least a relative position of the first mobile robot 100a.

For example, the communication unit of the first mobile robot 100a and the communication unit of the second mobile robot 100b exchange IR signals, ultrasonic signals, carrier frequencies, impulse signals, and the like, and analyze them through triangulation, so as to calculate movement displacements of the first mobile robot 100a and the second mobile robot 100b, thereby recognizing relative positions of the first mobile robot 100a and the second mobile robot 100b. However, the present disclosure is not limited to this method, and one of the various wireless communication technologies described above may be used to recognize the relative positions of the first mobile robot 100a and the second mobile robot 100b through triangulation or the like.

When the first mobile robot 100a recognizes the relative position with the second mobile robot 100b, the second mobile robot 100b may be controlled based on map information stored in the first mobile robot 100a or map information stored in the server, the terminal or the like. In addition, the second mobile robot 100b may share obstacle information sensed by the first mobile robot 100a. The second mobile robot 100b may perform an operation based on a control command (for example, a control command related to a traveling direction, a traveling speed, a stop, etc.) received from the first mobile robot 100a.

Specifically, the second mobile robot 100b performs cleaning while traveling along a traveling path of the first mobile robot 100a. However, the traveling directions of the first mobile robot 100a and the second mobile robot 100b do not always coincide with each other. For example, when the first mobile robot 100a moves or rotates up/down/right/left, the second mobile robot 100b may move or rotate up/down/right/left after a predetermined time, and thus current advancing directions of the first and second mobile robot 100a and 100b may differ from each other.

Also, a traveling speed Va of the first mobile robot 100a and a traveling speed Vb of the second mobile robot 100b may be different from each other.

The first mobile robot 100a may control the traveling speed Vb of the second mobile robot 100b to be varied in consideration of a distance at which the first mobile robot 100a and the second mobile robot 100b can communicate with each other. For example, if the first mobile robot 100a and the second mobile robot 100b move away from each other by a predetermined distance or more, the first mobile robot 100a may control the traveling speed Vb of the second mobile robot 100b to be faster than before. On the other hand, when the first mobile robot 100a and the second mobile robot 100b move close to each other by a predetermined distance or less, the first mobile robot 100a may control the traveling speed Vb of the second mobile robot 100b to be slower than before or control the second mobile robot 100b to stop for a predetermined time. Accordingly, the second mobile robot 100b can perform cleaning while continuously following up the first mobile robot 100a.

According to the present disclosure, the first mobile robot 100a may be provided with reception sensors on front and rear sides, so that the control unit of the first mobile robot 100a can recognize a receiving direction of an optical signal received from the second mobile robot 100b by distinguishing the front and rear sides. To this end, a UWB module may be provided at the rear of the first mobile robot 100a and another UWB module or a plurality of optical sensors may be disposed at the front of the first mobile robot 100a in a spacing manner. The first mobile robot 100a may recognize a receiving direction of an optical signal received from the second mobile robot 100b and determine whether the second mobile robot 100b is coming from behind it or is located at the front of it.

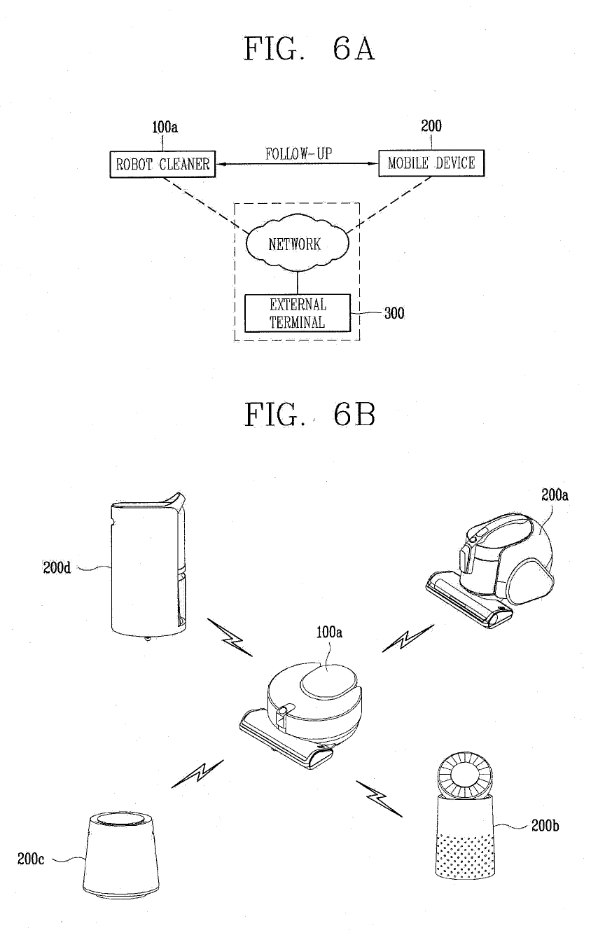

FIGS. 6A, 6B, and 6C are alternative embodiments of follow-up control between the first mobile robot and the second mobile robot in accordance with the present disclosure. Hereinafter, a follow-up control between the first mobile robot and a mobile device will be described in detail. Here, the follow-up control disclosed herein means only that the mobile device follows a movement path of the first mobile robot.

Referring to FIG. 6A, the first mobile robot 100a may control the follow-up of a mobile device 200 by communicating with the mobile device 200 instead of the second mobile robot.

Here, the mobile device 200 may not have a cleaning function, and may be any electronic device if it is provided with a driving function. For example, the mobile device 200 may include various types of home appliances or other electronic devices, such as a dehumidifier, a humidifier, an air purifier, an air conditioner, a smart TV, an artificial intelligent speaker, a digital photographing device, and the like, with no limit.

In addition, the mobile device 200 may be any device if it is equipped with a traveling function, and may not have a navigation function for detecting an obstacle by itself or traveling up to a predetermined destination.

The first mobile robot 100a is a mobile robot having both the navigation function and the obstacle detection function and can control the follow-up of the mobile device 200. The first mobile robot 100a may be a dry-type cleaner or a wet-type cleaner.

The first mobile robot 100a and the mobile device 200 can communicate with each other through a network (not shown), but may directly communicate with each other.

Here, the communication using the network is may be communication using, for example, WLAN, WPAN, Wi-Fi, Wi-Fi Direct, Digital Living Network Alliance (DLNA), Wireless Broadband (WiBro), World Interoperability for Microwave Access (WiMAX), etc. The mutual direct communication may be performed using, for example, UWB, Zigbee, Z-wave, Blue-Tooth, RFID, and Infrared Data Association (IrDA), and the like.

If the first mobile robot 100a and the mobile device 200 are close to each other, the mobile device 200 may be set to follow the first mobile robot 100a through a manipulation in the first mobile robot 100a.

If the first mobile robot 100a and the mobile device 200 are far away from each other, although not shown, the mobile device 200 may be set to follow the first mobile robot 100a through a manipulation in an external terminal 300 (see FIG. 5A).

Specifically, follow-up relationship between the first mobile robot 100a and the mobile device 200 may be established through network communication with the external terminal 300 (see FIG. 5A). Here, the external terminal 300 is an electronic device capable of performing wired or wireless communication, and may be a tablet, a smart phone, a notebook computer, or the like. At least one application related to follow-up control by the first mobile robot 100a (hereinafter, ‘follow-up related application’) may be installed in the external terminal 300. The user may execute the follow-up related application installed in the external terminal 300 to select and register the mobile device 200 subjected to the follow-up control by the first mobile robot 100a. When the mobile device 200 subjected to the follow-up control is registered, the external terminal may recognize product information of the mobile device, and such product information may be provided to the first mobile robot 100a via the network.

The external terminal 300 may recognize the position of the first mobile robot 100a and the position of the registered mobile device 200 through communication with the first mobile robot 100a and the registered mobile device 200. Afterwards, the first mobile robot 100a may travel toward the position of the registered mobile device 200 or the registered mobile device 200 may travel toward the position of the first mobile robot 100a according to a control signal transmitted from the external terminal 300. When it is detected that the relative positions of the first mobile robot 100a and the registered mobile device 200 are within a predetermined following distance, the follow-up control for the mobile device 200 by the first mobile robot 100a is started. After then, the follow-up control is performed by direct communication between the first mobile robot 100a and the mobile device 200 without the intervention of the external terminal 300.

The setting of the follow-up control may be released by the operation of the external terminal 300 or automatically terminated as the first mobile robot 100a and the mobile device 200 move away from the predetermined following distance.

The user can change, add or remove the mobile device 200 to be controlled by the first mobile robot 100a by manipulating the first mobile robot 100a or the external terminal 300. For example, referring to FIG. 6B, the first mobile robot 100a may perform the follow-up control for at least one mobile device 200 of another cleaner 200a or 100b, an air purifier 200b, a humidifier 200c, and a dehumidifier 200d.

Generally, since the mobile device 200 is different from the first mobile robot 100a in its function, product size, and traveling ability, it is difficult for the mobile device 200 to follow the movement path of the mobile robot 100a as it is. For example, there may be an exceptional situation in which it is difficult for the mobile device 200 to follow the movement path of the first mobile robot 100a according to a geographical characteristic of a space, a size of an obstacle, and the like. In consideration of such an exceptional situation, the mobile device 200 may travel or wait by omitting a part of the movement path even if it recognizes the movement path of the first mobile robot 100a. To this end, the first mobile robot 100a may detect whether or not the exceptional situation occurs, and control the mobile device 200 to store data corresponding to the movement path of the first mobile robot 100a in a memory or the like. Then, depending on situations, the first mobile robot 100a may control the mobile device 200 to travel with deleting part of the stored data or to wait in a stopped state.

FIG. 6C illustrates an example of a follow-up control between the first mobile robot 100a and the mobile device 200, for example, the air cleaner 200b having a traveling function. The first mobile robot 100a and the air purifier 200b may include communication modules A and B for determining relative positions thereof, respectively. The communication modules A and B may be one of modules for emitting and receiving an IR signal, an ultrasonic signal, a carrier frequency, or an impulse signal. The recognition of the relative positions through the communication modules A and B has been described above in detail, so a description thereof will be omitted. The air purifier 200b may receive traveling information corresponding to a traveling command (e.g., changes in traveling including a traveling direction and a traveling speed, traveling stop, etc.) from the first mobile robot 100a, travel according to the received traveling information, and perform air purification. Accordingly, the air purification may be performed in real time with respect to a cleaning space in which the first mobile robot 100a operates. In addition, since the first mobile robot 100a has already recognized the production information related to the mobile device 200, the first mobile robot 100a can control the air purifier 200b to record the traveling information of the first mobile robot 100a, and travel with deleting part of the traveling information or wait in a stopped state.

Hereinafter, description will be given in more detail of a method in which a plurality of mobile robots performs smooth following travel in accordance with one embodiment of the present disclosure, with reference to the accompanying drawings.

The first autonomous mobile robot 100a of the present disclosure may be referred to as a first mobile robot or a first mobile robot 100a and the second autonomous mobile robot 100b may be referred to as a second mobile robot or a second mobile robot 100b.

Also, in the present disclosure, the first mobile robot 100a may serve as a leading cleaner (or master cleaner) that travels in a direction ahead of the second mobile robot 100b, and the second mobile robot 100b may serve as a following cleaner (or slave cleaner) that follows the first mobile robot 100a.

The first and second mobile robots 100a and 100b may perform traveling and cleaning in a following manner without user's intervention.

In order for the second mobile robot 100b to follow the first mobile robot 100a, the second mobile robot 100b should determine or recognize the relative position of the first mobile robot 100a.

The second mobile robot 100b may detect a position of the first mobile robot 100a or a traveling path (or movement path) along which the first mobile robot 100a has traveled, in order to follow the first mobile robot 100a.

Hereinafter, a method in which the second mobile robot 100b travels while following the first mobile robot 100a will be described in more detail with reference to the accompanying drawings.

For convenience of explanation, the function/operation/control method of the second mobile robot 100b will be mainly described herein.

In this instance, the first mobile robot 100a may perform cleaning while moving in a space, in which the first mobile robot 100a can travel, according to a preset algorithm (for example, a cleaning algorithm, a traveling algorithm, etc.).

The second mobile robot 100b may perform a following travel that it moves (cleans) with following the first mobile robot 100a while the first mobile robot 100a is moving.

Since this disclosure describes the control method of the second mobile robot 100b, the second mobile robot 100b is referred to as a main body or a mobile robot, and the first mobile robot 100a is referred to as another mobile robot.

The mobile robot 100b of the present disclosure may include a traveling unit 1300 for moving or rotating the main body and a sensing unit 1400 for sensing the another mobile robot 100a in a detection area having a predetermined angle with respect to the front of the main body.

The mobile robot 100b of the present disclosure may also include a control unit 1800 that controls the traveling unit 1300 based on information sensed through the sensing unit 1400.

For example, the control unit 1800 may control the traveling unit 1300 to rotate the main body, in response to the another mobile robot 100a sensed in the detection area moving out of the detection area.

The control unit 1800 may control the traveling unit 1300 to move the main body toward the another mobile robot sensed in the detection area.

In this disclosure, the description that the control unit 1800 moves the main body or rotates the main body may mean that the control unit 1800 controls the traveling unit 1300 so that the main body moves or rotates.

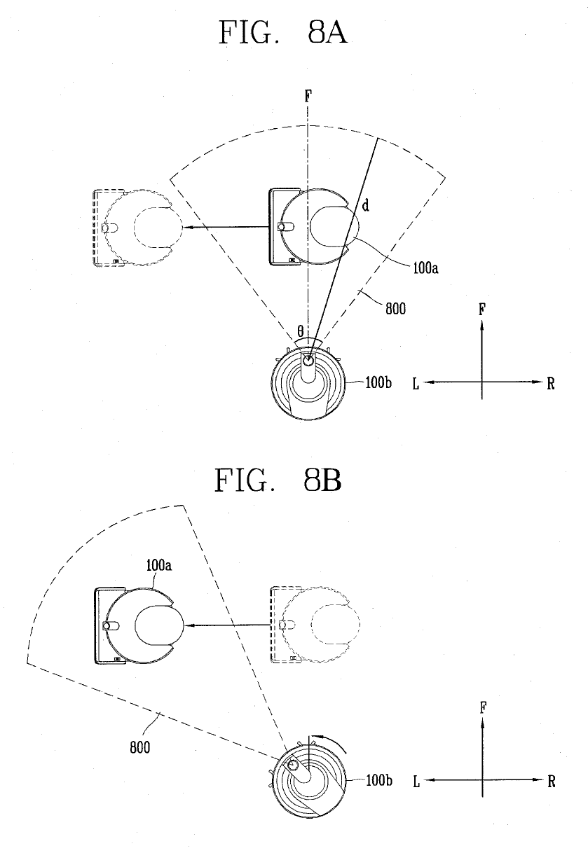

Referring to FIG. 8, the mobile robot (second mobile robot) 100b of the present disclosure may include a sensing unit 1400 that senses the another mobile robot (first mobile robot) 100a existing in a detection area 800 spanning a predetermined angle 8 (e.g., −n degrees to +n degrees (e.g., −45 degrees to +45 degrees) with respect to the front of the main body 100b.

The control unit 1800 of the mobile robot 100b may sense the another mobile robot 100a existing within a predetermined distanced in the detection area 800.

The detection area 800 may be a range which has the predetermined angle 8 and has the predetermined distance d as a radius. In addition, the detection area 800 may mean an area (range) in which predetermined information can be sensed by the sensing unit 1400.

The predetermined angle 8 and the predetermined distanced of the detection area 800 that can be sensed by the sensing unit 1400 may be determined according to a type of sensor which is provided in the sensing unit 1400 for a sensing operation or may be determined/changed by user setting.

For example, the sensing unit 1400 may include at least one of an optical sensor, a laser (infrared (IR)) sensor, an ultrasonic sensor, a Ultra-WideBand (UWB) sensor, one of wireless communication technologies (for example, one of Zigbee, Z-wave, Blue-Tooth and UWB), an external signal detection sensor (or external signal sensor), a front detection sensor (or front sensor), a cliff detection sensor (or cliff sensor), a two-dimensional (2D) camera sensor, and a three-dimensional (3D) camera sensor, or may be configured by combination of at least two of those sensors.

In addition, when the sensing unit 1400 senses the another mobile robot (or information related to the another mobile robot) in the detection area using one of the wireless communication technologies, the sensing unit 1400 may include the communication unit 1100 or may be replaced with the communication unit 1100.

The present disclosure can control the second mobile robot to follow the first mobile robot while keeping a predetermined interval range (or predetermined distance) from the first mobile robot. The predetermined interval range (for example, 50 to 70 cm) may include values which are smaller than the predetermined distance d (e.g., 2 to 100 m) of the detection area 800. In this disclosure, for the sake of convenience of description, in description of the detection area 800, the predetermined distance d of the detection area will not be mentioned and the detection area will be described as having a predetermined angle with respect to the front of the main body.

The control unit 1800 may sense various information in the detection area 800 through the sensing unit 1400.

For example, the control unit 1800 may sense another mobile robot existing in the detection area 800 through the sensing unit 1400 or sense information related to the another mobile robot existing in the detection area 800.

The information related to the another mobile robot may include a relative position between the another mobile robot 100a and the main body 100b, a traveling path of the another mobile robot 100a, a position (point) at which the another mobile robot 100a has been located, a traveling direction of the another mobile robot 100a, and the like.

In addition, the information related to the another mobile robot may include information related to the movement of the another mobile robot.

The control unit 1800 may sense the another mobile robot in the detection area having a predetermined angle with respect to the front of the main body (second mobile robot) 100b through the sensing unit 1400, and control the traveling unit 1300 such that the main body moves toward the sensed another mobile robot.

That is, the control unit 1800 may control the traveling unit 1300 to follow the another mobile robot 100a sensed in the detection area 800 through the sensing unit 1400.

Meanwhile, the another mobile robot 100a is the first mobile robot 100a, which is the leading (or master) cleaner of the present disclosure, and may autonomously travel (move and clean) according to a preset algorithm.

Accordingly, it may happen that the another mobile robot 100a moves out of the detection area 800 of the mobile robot 100b (second mobile robot) due to the traveling of the another mobile robot 100a. In this case, the mobile robot 100b may not sense the another mobile robot 100a and may be difficult to follow the another mobile robot 100a.

The present disclosure provides a control method by which the mobile robot 100b can travel with smoothly following the another mobile robot 100a even when such a situation occurs.

Hereinafter, description will be made in detail of a method by which a mobile robot can travel with following another mobile robot even when the another mobile robot deviates from the detection area of the mobile robot, with reference to the accompanying drawings.

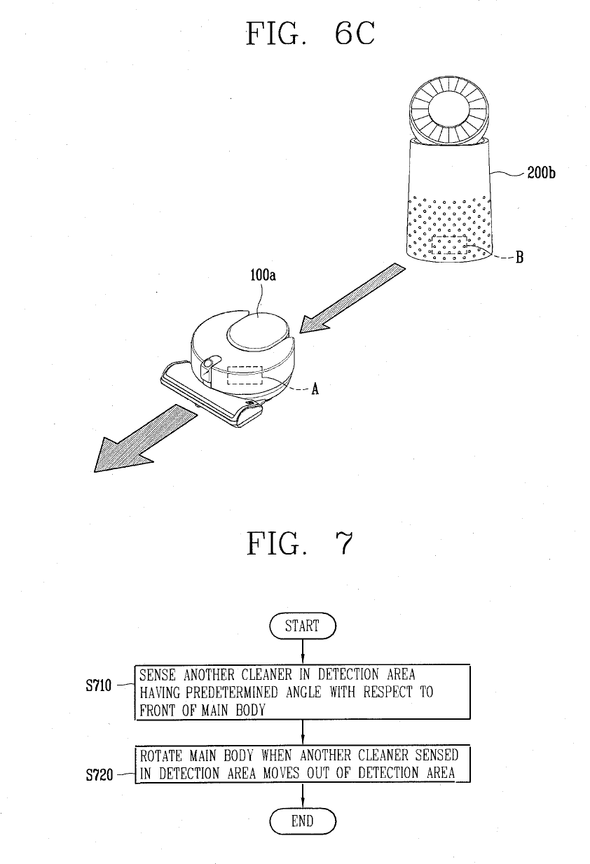

FIG. 7 is a flowchart illustrating a representative control method according to the present disclosure, and FIGS. 8A, 8B, 9A, 9B, 10A, and 10B are conceptual views illustrating the control method illustrated in FIG. 7.

Referring to FIG. 7, another mobile robot is sensed in a detection area of a main body having a predetermined angle with respect to the front of the main body (S710).

More specifically, as shown in FIG. 8A, the control unit 1800 of the mobile robot (second mobile robot) 100b may detect (sense) the another mobile robot (first mobile robot) 100a within a detection area 800 having a predetermined angle θ with respect to the front of the main body 100b.

For example, the another mobile robot 100a may continuously output a signal (e.g., a UWB signal, an infrared signal, a laser signal, an ultrasonic signal, etc.) so that its position can be determined by the mobile robot (second mobile robot) 100b.

The control unit 1800 may receive the signal through the sensing unit 1400 (or the communication unit 1100) and determine the position (relative position) of the another mobile robot 100a based on the signal.

For example, the control unit 1800 may be configured to receive a signal received in the detection area 800. The control unit 1800 may determine the position (relative position) of the another mobile robot 100a when a signal (e.g., a UWB signal, an IR signal, a laser signal, an ultrasonic signal, etc.) transmitted from the another mobile robot 100a existing in the detection area 800 is received through the detection area 800.

The control unit 1800 may determine the position of the another mobile robot 100a in real time or periodically at predetermined time intervals. The control unit 1800 may determine (detect) the position of the another mobile robot 100a not only while the main body 100b is stopped but also while the main body is moving (rotating).

The position of the another mobile robot 100a may be determined based on one point of the another mobile robot, for example, and may be determined based on the center of the another mobile robot. However, the present disclosure is not limited to this, and the position of the another mobile robot 100a may be determined based on various points of the another mobile robot.

For example, the control unit 1800 may decide a point where the center of the another mobile robot 100a is located as the position of the another mobile robot 100a. In addition, the position of the another mobile robot 100a may be determined based on a point (area) on which an antenna for transmitting signals in the another mobile robot 100a is provided.

In this case, the control unit 1800 may determine the position of the another mobile robot 100a based on the point where the antenna for transmitting signals in the another mobile robot 100a is located.

The control unit 1800 may control the traveling unit 1300 so that the main body 100b faces the another mobile robot 100a, based on the signal received from the another mobile robot 100a. For example, the control unit 1800 may determine the position of the another mobile robot 100a (the center of the another mobile robot or the point where the antenna is provided on the another mobile robot) based on the signal transmitted from the another mobile robot 100a, and control the traveling unit 1300 to move the main body 100b toward the point where the another mobile robot 100a is located.

Thereafter, according to the present disclosure, the main body 100b is rotated as the another mobile robot sensed in the detection area moves out of the detection area (S720).

In detail, as illustrated in FIG. 8B, the control unit 1800 of the mobile robot (second mobile robot) 100b may detect through the sensing unit 1400 that the another mobile robot 100a sensed in the detection area 800 is moving away from the detection area 800.

For example, when the another mobile robot 100a which is receiving the signal from the another mobile robot 100a existing in the detection area 800 moves out of the detection area 800, the control unit 1800 may not receive the signal transmitted from the another mobile robot 100a.

The control unit 1800 may determine that the another mobile robot 100a is out of the detection area 800 when it is sensed (determined) that the signal which was being received is not received any more.

The control unit 800 may control the traveling unit 1300 to rotate the main body, in response to the another mobile robot 100a sensed in the detection area moving out of the detection area 800.

More specifically, when the another mobile robot 100a moves out of the detection area 800 (or when it is sensed through the sensing unit 1400 that the another mobile robot 100a is moving out of the detection area 800), the control unit 1800 may rotate the main body 100b so that the another mobile robot 100a is located back in the detection area 800.

For example, as shown in FIG. 8A, the control unit 1800 may sense the another mobile robot 100a located in the detection area 800 through the sensing unit 1400.

In this state, a case where the another mobile robot 100a moves out of the detection area 800 due to its movement may occur.

In this instance, when the another mobile robot 100a moves out of the detection area 800, the control unit 1800 may rotate the main body 100a such that the another mobile robot 100a is located back in the detection area 800.

At this time, the control unit 1800 may determine a direction in which the another mobile robot 100a is moving out of the detection area 800 through the sensing unit 1400. Then, the control unit 1800 may rotate the main body 100b in a direction corresponding to the determined direction.

For example, the control unit 1800 may sense the position of the another mobile robot 100a in real time plural times based on a signal received from the another mobile robot 100a sensed in the detection area 800, and determine a traveling direction (or traveling path) of the another mobile robot based on a plurality of positions of the another mobile robot determined by the plural sensing operations.

The plurality of positions of the another mobile robot may be included in the traveling path made by the another mobile robot 100a in the detection area 800.

The control unit 1800 may determine (predict, estimate or sense) in which direction the another mobile robot 100a has moved away from the detection area 800, based on the position of the another mobile robot (the traveling direction or traveling path of the another mobile robot) sensed while the signal is received, when the signal which was being received from the another mobile robot 100a existing in the detection area 800 is not received any more.

For example, as illustrated in FIG. 8A, the control unit 1800 may sense through the sensing unit 1400 that the another mobile robot 100a is moving out of the detection area 800 in a left direction (L). When the another mobile robot 100a is moving out of the detection area 800 in the left direction (L), the control unit 1800 may rotate the main body 100b in the left direction.

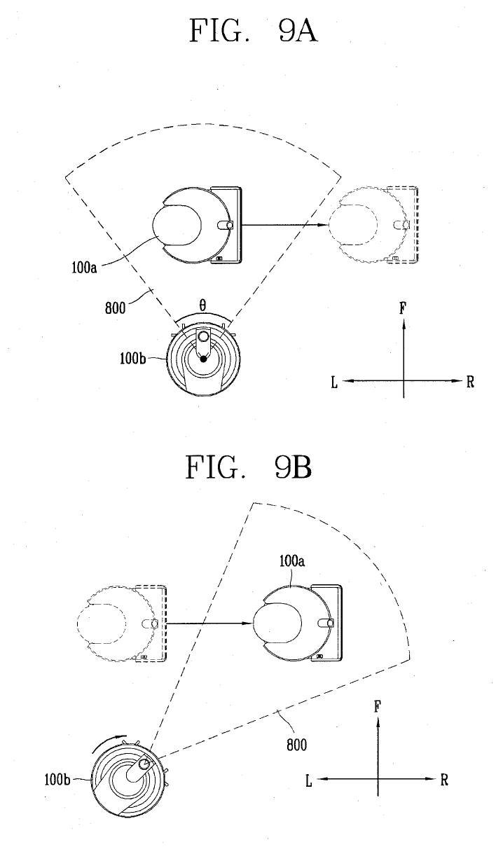

As another example, as illustrated in FIG. 9A, the control unit 1800 may sense through the sensing unit 1400 that the another mobile robot 100a is moving out of the detection area 800 in a right direction (R). When the another mobile robot 100a is moving out of the detection area 800 in the right direction (R), the control unit 1800 may rotate the main body 100b in the right direction.

Rotating the main body 100b in the left or right direction may mean rotating the main body 100b to left or right with respect to the front (F) of the main body 100b.

The control unit 1800 may then stop the rotation of the main body 100b when the another mobile robot 100a is sensed in the detection area 800 again due to the rotation of the main body 100b.

The control unit 1800 may rotate the main body 100b until a center line of the detection area 800 (or a reference line toward the front of the main body 100b) faces one point of the another mobile robot (e.g., the antenna transmitting a signal or the center of the another mobile robot), and stop the rotation of the main body 100b, in response to the center line of the detection area 800 facing the one point of the another mobile robot.

If the another mobile robot 100a continues to move while the main body 100b is rotating, the control unit 1800 may rotate the main body 100b until a preset condition is satisfied and stop the rotation based on the satisfaction of the preset condition.

The preset condition may include at least one of a case where a distance between the main body and the another mobile robot is a predetermined distance or more and/or a case where a traveling distance by which the main body has to travel sequentially via the first point 1200a and the second point 1200b (a traveling distance by which the main body 100b has to travel along a traveling path of the another mobile robot 100a or a traveling distance by which the main body 100b has to travel sequentially via all of points where the another mobile robot 100a has been located) is a predetermined distance or more.

In other words, when the another mobile robot 100a has moved out of the detection area 800, the main body can be rotated in a direction that the another mobile robot has moved out of the detection area 800 such that the another mobile robot 100a can be located back in the detection area (or the another mobile robot 100a can be sensed in the detection area again).

When the another mobile robot (first mobile robot) 100\a is sensed again by virtue of the rotation of the main body, the mobile robot (second mobile robot) 100b of the present disclosure may continuously travel along the another mobile robot 100a.

In this manner, an operation that the main body is rotated such that the another mobile robot belongs to the detection area again when the another mobile robot 100a has moved out of the detection area may be referred to as a searching operation.

Hereinafter, a method in which the mobile robot 100b follows the another mobile robot 100a will be described in more detail, with reference to the accompanying drawings.

The description given with reference to FIGS. 7 to 9 will be equally applied to the following description.

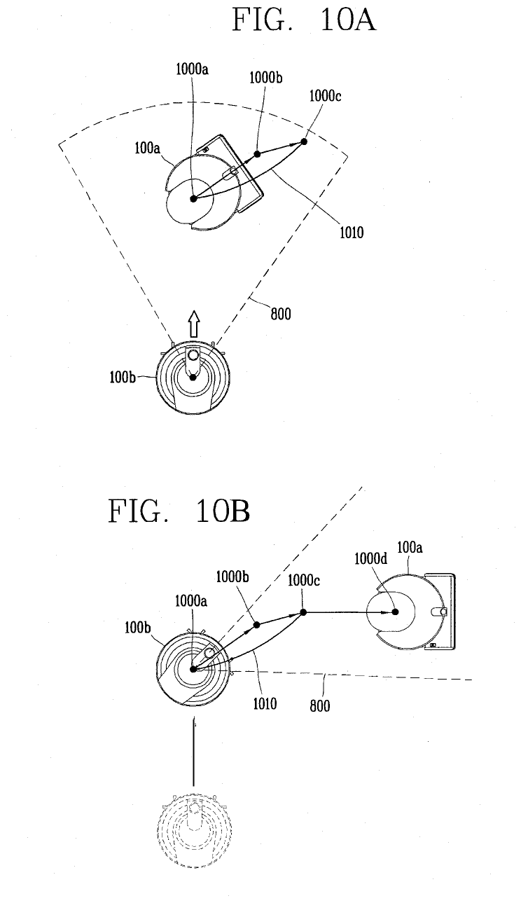

As illustrated in FIG. 10A, the control unit 1800 may control the traveling unit 1300 so that the main body 100b is moved toward the another mobile robot 100a sensed in the detection area 800.

Specifically, the control unit 1800 may sense the another mobile robot 100a in the detection area 800 having a predetermined angle with respect to the front of the main body, and control the main body 100a to move toward the sensed another mobile robot 100a so as to follow (travel along) the another mobile robot 100a.

On the other hand, while the main body 100b is traveling toward the another mobile robot 100a, the another mobile robot 100a may move to another (different) place.

The control unit 1800 may sense (determine) a traveling path 1010 of the another mobile robot 100a sensed in the detection area 800 through the sensing unit 1400.

For example, the control unit 1800 may sense the relative position (or position) of the another mobile robot 100a existing in the detection area 800 at real time or at predetermined time intervals, and sense (or determine) the traveling path of the another mobile robot 100a based on the sensed relative position.

The control unit 1800, as illustrated in FIG. 10B, may control the main body 100b to travel to correspond to the traveling path 1010 of the another mobile robot 100a sensed in the detection area 800.

Here, controlling the main body 100b to travel to correspond to the traveling path 1010 of the another mobile robot 100a may mean that the main body 100b travels while following the another mobile robot 100a along substantially the same path as the traveling path along which the another mobile robot 100a has traveled.

As illustrated in FIG. 10A, the control unit 1800 may determine at least one point 1000a, 1000b, 1000c corresponding to the position (relative position) of the another mobile robot 100a sensed in the detection area 800 through the sensing unit 1400.

The at least one point corresponding to the position of the another mobile robot 100a may be plural according to the movement of the another mobile robot 100a.

The control unit 1800 may determine the at least one point 1000a, 1000b, 1000c corresponding to the position of the another mobile robot 100a sensed in the detection area 800 and control the traveling unit 1300 to move the main body 100b toward the determined at least one point 1000a, 1000b, and 1000c.

Specifically, the control unit 1800 may sequentially determine a plurality of positions of the another mobile robot 100a, which are made due to the movement of the another mobile robot 100a in the detection area 800, according to a lapse of time.

Also, the control unit 1800 may cause the main body 100b to travel sequentially via the plurality of points 1000a, 1000b, 1000c corresponding to the plurality of positions according to the determined sequence.

As illustrated in FIG. 10B, when the plurality of positions of the another mobile robot 100a are determined in the sequence of a first position, a second position, and a third position within the detection area 800, the control unit 1800 may control the main body to move to the first point 1000a corresponding to the first position and then move to the second point 1000b corresponding to the second position. When the main body 100b reaches the second point 1000b, the control unit 1800 may cause the main body 100b to travel to the third point 1000b corresponding to the third position.

While the main body 100b travels via the plurality of points 1000a, 1000b and 1000c, the another mobile robot 100a may move to another point 1000d.

The control unit 1800, as illustrated in FIG. 10B, may determine a new position of the another mobile robot in response to the movement of the another mobile robot 100a even while traveling via the plurality of points, and cause the main body 100b to move to the point 1000d corresponding to the new position after traveling via the plurality of points.

In summary, a point corresponding to the position of the another mobile robot may be referred to as a node. The control unit 1800 may generate a plurality of nodes that the another mobile robot 100a has traveled (been located) sequentially according to the lapse of time, based on the position of the another mobile robot sensed in the detection area 800, and control the main body 100b to travel sequentially via the plurality of nodes.

The control unit 1800 may delete information related to any one of the nodes when the main body 100b moves to another node of the plurality of nodes (a plurality of points) via the one node.

As described above, an operation in which the main body 100b travels via a node (point) where the another mobile robot has been located may be referred to as a node clear operation.

Hereinafter, description will be given in more detail of a method in which the second mobile robot 100b follows the first mobile robot 100a by combining the searching operation and the node clear operation described with reference to FIGS. 7 to 10, with reference to the accompanying drawings.

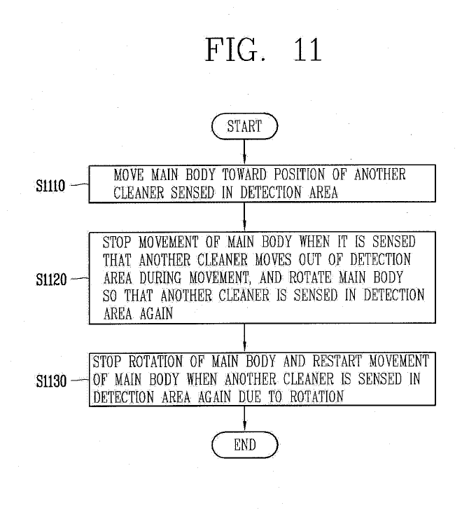

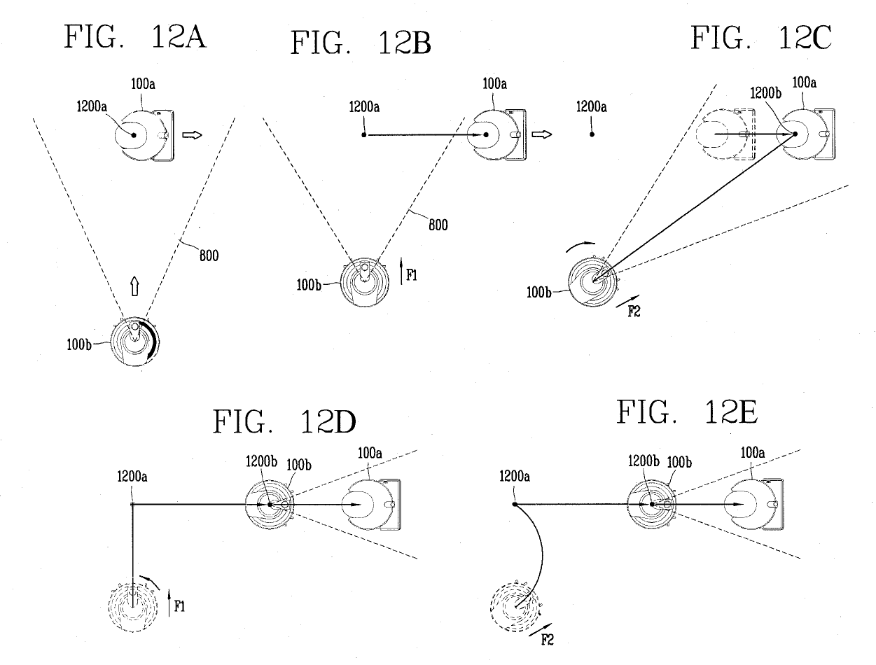

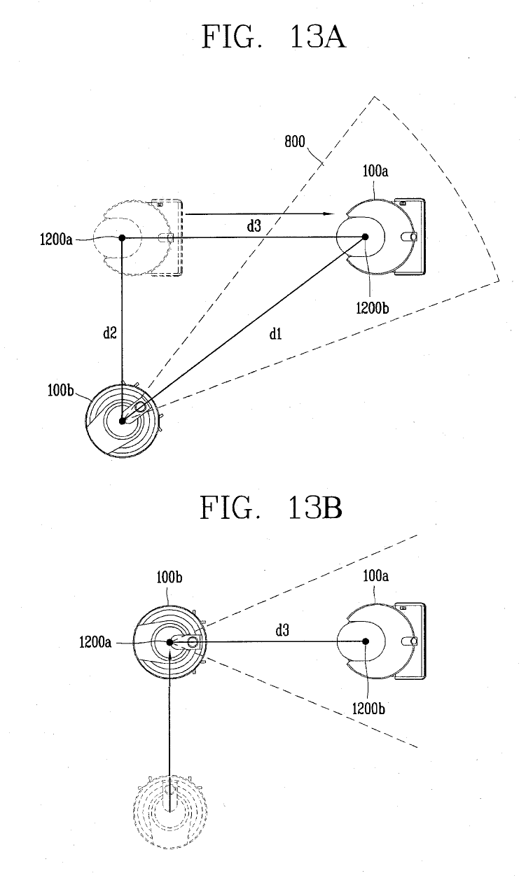

FIG. 11 is a flowchart illustrating a more detailed control method according to the present disclosure, and FIGS. 12 and 13 are conceptual views illustrating the control method illustrated in FIG. 11.

The description given with reference to FIGS. 7 to 10 will be applied equally to the following description.

Referring to FIG. 11, the mobile robot 100b of the present disclosure may move the main body toward the position of the another mobile robot 100a sensed in the detection area 800 (S1110).

In detail, the control unit 1800 of the mobile robot 100b may move the main body 100b toward the another mobile robot 100a which is sensed in the detection area 800 having a predetermined angle with respect to the front of the main body 100b.

In other words, the control unit 1800 may determine a point corresponding to the position of the another mobile robot 100a sensed in the detection area 800, and control the traveling unit 1300 to move the main body 100b toward the point corresponding to the position of the another mobile robot 100a.

At this time, the movement of the another mobile robot 100a (or the movement of the main body 100b) may cause the another mobile robot 100a to be out of the detection area 800.

The control unit 1800 may stop the movement of the main body 100b, based on the sensing result that the another mobile robot 100a is moving out of the detection area 800 during the movement of the main body 100b, and rotate the main body 100b so that the another mobile robot 100a is sensed in the detection area 80 again. The description given with reference to FIGS. 7 to 9 will be applied equally/similarly to the contents of the step S1120.

When the another mobile robot 100a is sensed again in the detection area 800 according to the rotation of the main body 100b, the control unit 1800 may stop the rotation of the main body 100b and restart the movement of the main body (S1130).

The foregoing description will be made clearer with reference to FIG. 12.

As illustrated in FIG. 12A, the control unit 1800 may control the main body 100b to move toward the another mobile robot 100a sensed in the detection area 800.

For example, the control unit 1800 may determine a first point 1200a corresponding to the position of the another mobile robot 100a sensed in the detection area 800, and control the main body 100b to move toward the first point 1200a.

As illustrated in FIG. 12B, the control unit 1800 may sense through the sensing unit 1400 that the another mobile robot 100a is moving out of the detection area 800 during the movement of the main body 100b.

In this case, the control unit 1800 may stop the movement of the main body 100b when it is sensed that the another mobile robot 100a is moving out of the detection area 800 during the movement of the main body 100b, and as illustrated in FIG. 12C, may rotate the main body so that the another mobile robot 100b is sensed in the detection area 80 again.

For example, when it is sensed that the another mobile robot 100a is moving out of the detection area 800 in one direction (for example, in a right direction), the control unit 1800 may rotate the main body in a direction corresponding to the one direction (e.g., in the right direction). This is to allow the another mobile robot 100a to be sensed again in the detection area 800.

As illustrated in FIG. 12C, when the another mobile robot 100a is sensed again in the detection area 800 according to the rotation of the main body 100b, the control unit 1800 may stop the rotation of the main body 100b and restart the movement of the main body 100b, as illustrated in FIGS. 12D or 12E.

In the state where the main body 100b faces a first direction F1, the control unit 1800, as illustrated in FIGS. 12A and 12B, may determine the first point 1200a corresponding to the position of the another mobile robot 100a.

Afterwards, when the another mobile robot 100b moves out of the detection area 800, the control unit 1800 may rotate the main body 100a such that the another mobile robot 100a is sensed back in the detection area 800.

As illustrated in FIG. 12C, in the state where the main body faces a second direction F2, the control unit 1800 may determine the second point 1200b corresponding to the position of the another mobile robot 100a.

In the state where the main body faces the second direction F2, the control unit 1800 may sense (determine) a plurality of points corresponding to a plurality of positions of the another mobile robot 100a sensed in the detection area 800.

Thereafter, the control unit 1800 may stop the rotation based on a satisfaction of a preset condition, and control the main body to travel sequentially via the first point 1200a and the second point 1200b.

Here, as illustrated in FIGS. 12C and 12D, for example, when a preset condition is satisfied while the main body 100b faces the second direction F2, the control unit 1800 may rotate the main body 100b to face the first direction F1 and control the main body to travel sequentially via the first point 1200a and the second point 1200b.

As another example, when the preset condition is satisfied while the main body 100b faces the second direction F2, as illustrated in FIG. 12D, the control unit 1800 may skip the operation of rotating the main body 100b to face the first direction F1 and immediately control the main body 100b to travel sequentially via the first point 1200a and the second point 1200b.

In this case, since the operation of rotating the main body 100b to face the first direction F1 is skipped, the traveling path along which the main body 100b is moved may form a curved shape at a partial section, as illustrated in FIG. 12E.

Thereafter, the control unit 1800 may stop the rotation of the main body 100b based on the satisfaction of the preset condition, and control the main body to travel sequentially via the first point 1200a and the second point 1200b.

Here, the preset condition may include at least one of a case where a distance between the main body and the another mobile robot is a predetermined distance or more and/or a case where a traveling distance by which the main body has to travel sequentially via the first point 1200a and the second point 1200b (a traveling distance by which the main body 100b has to travel along a traveling path of the another mobile robot 100a or a traveling distance by which the main body 100b has to travel sequentially via all of points that the another mobile robot 100a has been located) is a predetermined distance or more.

The control unit 1800 may sense (determine) a distance between the another mobile robot 100a and the main body 100b even when the another mobile robot 100a moves out of the detection area 800. For example, when the another mobile robot 100a moves out of the detection area 800, the control unit 1800 may sense the distance between the another mobile robot 100a and the main body 100b in real time or at predetermined time intervals using the communication unit 1100 or sensors which sense other areas except for the detection area.

The control unit 1800 may sense (determine) a traveling distance by which the main body has to travel sequentially via the first point 1200a and the second point 1200b (or a traveling distance by which the main body 100b has to travel along the traveling path of the another mobile robot 100a or a traveling distance by which the main body 100b has to travel sequentially via all the points where the another mobile robot 100a has been located), based on a position of the another mobile robot which is sensed before the rotation of the main body 100b and a position of the another mobile robot which is sensed after the rotation of the main body 100b.

Referring to FIG. 13A, the preset condition may include at least one of a case where a distance between the main body 100b and the another mobile robot 100a is a predetermined distance or more and/or a case where a traveling distance (d2+d3) by which the main body 100b has to travel sequentially via the first point 1200a and the second point 1200b (a traveling distance (d2+d3) by which the main body 100b has to travel along a traveling path of the another mobile robot 100a or a traveling distance (d2+d3) by which the main body 100b has to travel sequentially via all of points that the another mobile robot 100a has been located) is a predetermined distance or more.

The predetermined distances may be determined at the time of release of a product, or may be determined/changed by user setting.

Accordingly, the present disclosure may prevent the first mobile robot 100a and the second mobile robot 100b from being too far away from each other.

While the main body 100b rotates in place, the distance between the main body 100b and the another mobile robot 100a (or the traveling distance by which the main body has to travel along the traveling path of the another mobile robot) may further increase.

In this case, in order to maintain a predetermined distance between the main body 100b and the another mobile robot 100a, it is necessary to temporarily stop the traveling of the another mobile robot 100a or increasing moving speed of the second mobile robot 100a.

The control unit 1800 may control the traveling unit 1300 to move the main body 100b at a faster moving speed (traveling speed) for a predetermined time, based on the satisfaction of the preset condition.

For example, the control unit 1800 may stop the movement of the main body and rotate the main body when the another mobile robot 100a moves out of the detection area while moving the main body at a first speed.

Then, when the movement of the main body 100b is restarted in response to the satisfaction of the preset condition, the control unit 1800 may move the main body 100b at a second speed that is faster than the first speed for a predetermined period of time. Afterwards, as illustrated in FIG. 13B, when the distance between the main body 100b and the another mobile robot 100a becomes a predetermined distance d3 or less, the control unit 1800 may restore (reduce) the moving speed of the main body 100b to the first speed.

The control unit 1800 may control the moving speed of the main body 100b such that the main body 100b and the another mobile robot 100a keep spaced apart from each other by the predetermined distance.

On the other hand, the present disclosure can restrict the movement of the another mobile robot 100a to prevent a further increase in the spaced distance between the main body 100b and the another mobile robot 100a (or the traveling distance by which the main body has to travel along the traveling path of the another mobile robot), which is caused due to the traveling of the another mobile robot while the main body 100b rotates in place.

Hereinafter, description will be given in more detail of a control method for maintaining a predetermined distance between the main body 100b and the another mobile robot 100a (or a predetermined traveling distance by which main body has to travel along the traveling path of the another mobile robot).

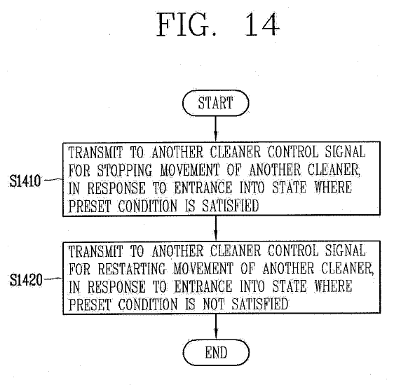

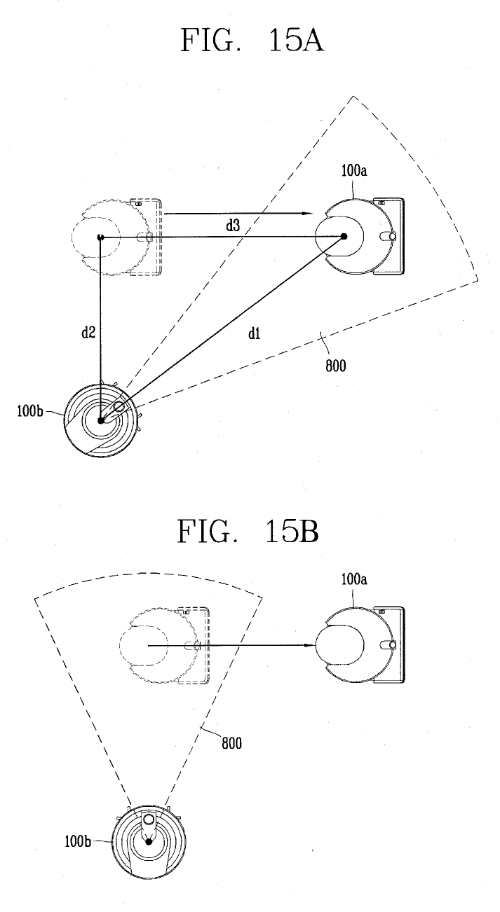

FIG. 14 is a flowchart illustrating an additional control method according to the present disclosure, and FIG. 15 is a conceptual view illustrating the control method illustrated in FIG. 14.

The description given with reference to FIGS. 7A to 13 will be applied equally/similarly to the following description.

The mobile robot (second mobile robot) 100b of the present disclosure may include the communication unit 1100 that performs communication with the another mobile robot 100a. Likewise, the another mobile robot (first mobile robot) 100a may include the communication unit 1100 as well.

Referring to FIG. 14, the control unit 1800 of the mobile robot (second mobile robot) 100b of the present disclosure may transmit a control signal for stopping the movement of the another mobile robot 100a to the another mobile robot 100a through the communication unit 1100, in response to entrance into the state where the aforementioned preset condition is satisfied (S1410).

The preset condition, as illustrated in FIG. 13A and FIG. 15A, may include at least one of a case where a distance dl between the main body 100b and the another mobile robot 100a becomes a predetermined distance or more and/or a case where a traveling distance (d2+d3) by which the main body 100b has to travel along a traveling path of the another mobile robot 100a (or a traveling distance by which the main body 100b has to travel sequentially via all of points where the another mobile robot 100a has been located) is a predetermined distance or more.

In this case, the another mobile robot 100a may stop its movement (or pause), in response to reception of the control signal.

The control unit 1800 may transmit a control signal for restarting the movement of the another mobile robot 100a to the another mobile robot 100a through the communication unit 1100, in response to entrance into a state where the preset condition is not satisfied from the state where the preset condition is satisfied (S1420).

Here, the entrance into the state where the preset condition is not satisfied may include, for example, a case where the distance dl becomes shorter than the predetermined distance or the traveling distance d2+d3 becomes shorter than the predetermined distance due to the movement of the main body 100b.

When the distance between the main body 100b and the another mobile robot 100a (or the traveling distance by which the main body 100b has to travel along the traveling path of the another mobile robot 100a) becomes the predetermined distance as the movement of the main body 100b is restarted, the control unit 1800 may also transmit a control signal for restarting the movement of the another mobile robot 100a to the another mobile robot 100a through the communication unit 1100.

The another mobile robot 100a may restart its movement, in response to reception of the control signal for restarting the movement of the another mobile robot 100a.

As another example, as illustrated in FIG. 15B, when the another mobile robot 100a is out of the detection area 800, the control unit 1800 may transmit a control signal for stopping the movement of the another mobile robot 100a to the another mobile robot 100a through the communication unit 1100.

In this case, the another mobile robot 100a may stop its movement (or pause), in response to reception of the control signal for stopping the movement of the another mobile robot 100a.

Afterwards, when the another mobile robot 100a is sensed again in the detection area 800 by the rotation of the main body 100b after the another mobile robot 100a has moved out of the detection area 800, the control unit 1800 may transmit a control signal for restarting the movement of the another mobile robot 100a to the another mobile robot 100a through the communication unit 1100.

With such a configuration of the present disclosure, when the another mobile robot is out of the detection area and/or when the distance between the main body and the another mobile robot (the traveling distance by which the main body has to travel along the traveling path of the another mobile robot) increases, the main body can be controlled to rotate so as to prevent the main body and the another mobile robot from being far away from each other while performing the searching operation.

The foregoing description will be applied to the method of controlling the mobile robot (second mobile robot) 100b in the same/similar manner.

For example, the control method of the mobile robot may include sensing another mobile robot in a detection area having a predetermined angle with respect to the front of a main body, and rotating the main body when the another mobile robot sensed in the detection area moves out of the detection area.

The function/operation/control method of the mobile robot 100b described in this disclosure may alternatively be performed by the control unit of the another mobile robot (first mobile robot) 100a.

For example, when the mobile robot 100b travels ahead and the another mobile robot 100a follows the mobile robot 100b, the function/operation/control method of the control unit 1800 of the mobile robot 100b described in this disclosure may be performed by the control unit of the another mobile robot 100a in the same/similar manner.

Whether the first mobile robot 100a is to follow the second mobile robot 100b or the second mobile robot 100b is to follow the first mobile robot 100a may be determined at the time of product manufacture and may be determined/changed by user setting.

The present disclosure provides a plurality of autonomous mobile robots capable of accurately determining a relative position of another mobile robot.

The present disclosure provides mobile robots capable of smoothly performing a following travel in a manner that another mobile robot follows a mobile robot without failure even if the another mobile robot moves out of a detection area of the mobile robot.

The present disclosure provides a new following control method, capable of preventing a mobile robot from missing another mobile robot by rotating the mobile robot so as to detect the another mobile robot again in a detection area of the mobile robot when the another mobile robot moves out of the detection area, and allowing the mobile robot to follow the another mobile robot even if the another mobile robot moves out of the detection area of the mobile robot.

The present disclosure provides mobile robots that a mobile robot can always recognize a relative position or a traveling path of another mobile robot by way of rotating the mobile robot so that the another mobile robot can be sensed again within a detection area of the mobile robot when the another mobile robot moves out of the detection area.

The present disclosure described above can be implemented as computer-readable codes on a program-recorded medium. The computer readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like. In addition, the computer may also include the control unit 1800. The above detailed description should not be limitedly construed in all aspects and should be considered as illustrative. The scope of the present disclosure should be determined by rational interpretation of the appended claims, and all changes within the scope of equivalents of the present disclosure are included in the scope of the present disclosure.

What is claimed is:

1. A mobile robot, comprising:
a main body;
a traveling unit configured to move or rotate the main body;
a sensor configured to detect another mobile robot in a detection area spanning a predetermined angle with respect to a front of the main body; and
a controller configured to rotate the detection area when the other mobile robot detected within the detection area moves out of the detection area.

2. The robot of claim 1, wherein when the other mobile robot moves out of the detection area, the controller is configured to rotate the detection area so that the other mobile robot is repositioned in the detection area.

3. The robot of claim 1, wherein the controller is configured to
determine, using the sensor, a direction in which the other mobile robot moves out of the detection area, and
rotate the detection area in a direction corresponding to the determined direction.

4. The robot of claim 1, wherein the controller is configured to
rotate the detection area in a left direction when the other mobile robot moves out of the detection area in the left direction, and
rotate the detection area in a right direction when the another mobile robot moves out of the detection area in the right direction.

5. The robot of claim 1, wherein the controller is configured to control the wheel to move the main body toward the other mobile robot detected within the detection area.

6. The robot of claim 1, wherein the controller is configured to cause the main body to travel corresponding to a traveling path of the other mobile robot detected within the detection area.

7. The robot of claim 1, wherein the controller is configured to
determine at least one point corresponding to a position of the other mobile robot detected within the detection area, and
controls the traveling unit to move the main body to the determined at least one point.

8. The robot of claim 1, wherein the controller is configured to
determine a plurality of positions of the other mobile robot within the detection area in a sequential manner according to a lapse of time, in response to the movement of the other mobile robot, and
control the main body to travel via a plurality of points corresponding to the plurality of positions in the sequential manner.

9. The robot of claim 1, wherein the controller is configured to
move the main body to a position of the other mobile robot within the detection area,
stop the movement of the main body to rotate the detection area so that the other mobile robot is detected within the detection area again when it is detected that the another mobile robot moves out of the detection area during the movement, and
stop the rotation of the detection area to restart the movement of the main body when the other mobile robot is sensed within the detection area again due to the rotation.

10. The robot of claim 1, wherein the controller is configured to
determine a first point corresponding to a position of the another mobile robot detected within the detection area while the main body faces a first direction,
rotate the detection area so that the other mobile robot is detected within the detection area again when the other mobile robot moves out of the detection area,
determine a second point corresponding to a position of the other mobile robot detected within the detection area while the main body faces a second direction due to the rotation, and
stop the rotation and then control the main body to travel sequentially via the first point and the second point when a preset condition is satisfied.

11. The robot of claim 10, wherein the preset condition includes at least one of a case where a distance between the main body and the other mobile robot is a predetermined distance or more, and a case where a traveling distance by which the main body has to travel sequentially via the first point and the second point is a predetermined distance or more.

12. The robot of claim 10, wherein the controller is configured to
rotate the main body to face the first direction, and
control the main body to travel sequentially via the first point and the second point when the preset condition is satisfied while the main body faces the second direction.

13. The robot of claim 1, further comprising a communication unit to perform communication with the another mobile robot,
wherein the controller transmits to the another mobile robot a control signal for stopping the movement of the another mobile robot through the communication unit, in response to an entrance into a state where a preset condition is satisfied.

14. The robot of claim 13, wherein the preset condition includes at least one of a case where a distance between the main body and the another mobile robot is a predetermined distance or more, and a case where a traveling distance by which the main body has to travel along a traveling path of the another mobile robot is a predetermined distance or more.

15. The robot of claim 13, wherein the controller transmits to the another mobile robot a control signal for restarting the movement of the another mobile robot through the communication unit, in response to an entrance into a state where the preset condition is not satisfied from the state where the preset condition is satisfied.

16. The robot of claim 1, further comprising a transceiver configured to perform communication with the another mobile robot,
wherein the controller is configured to transmit to the other mobile robot a control signal for stopping the movement of the other mobile robot through the transceiver when the another mobile robot moves out of the detection area.

17. The robot of claim 16, wherein the controller is configured to transmit to the other mobile robot a control signal for restarting the movement of the other mobile robot through the transceiver when the another mobile robot is detected within the detection area again due to the rotation of the detection area after the other mobile robot has moved out of the detection area.

18. A method for controlling a mobile robot, the method comprising:
detecting another mobile robot within a detection area spanning a preset angle with respect to the front of a main body; and
rotating the detection area when the other mobile robot detected within the detection area moves out of the detection area.

19. The robot of claim 1, wherein the controller is configured to control the traveling unit to rotate the detection area when the other mobile robot detected within the detection area moves out of the detection area.

20. The robot of claim 1, wherein the controller is configured to rotate the main body to rotate the detection area when the other mobile robot detected within the detection area moves out of the detection area.

21. The method of claim 18, wherein rotating the detection area further comprises rotating the main body.
